(19) United States
(12) Patent Application Publication
(10) Pub. No.: US 2025/0329937 A1
(43) Pub. Date: Oct. 23, 2025

(54) MANAGING OPTICAL ANTENNA ELEMENT COUPLING FOR OPTICAL WAVES TRANSMITTED TO AND RECEIVED FROM A TARGET REGION

(71) Applicant: Analog Photonics LLC, Boston, MA (US)

(72) Inventors: Jonathan Andrew Guglielmon, Cambridge, MA (US); Conor J. Sheil, Cambridge, MA (US); Michae Robert Watts, Hingham, MA (US)

(73) Assignee: Analog Photonics LLC, Boston, MA (US)

(21) Appl. No.: 19/184,156

(22) Filed: Apr. 21, 2025

Related U.S. Application Data
(60) Provisional application No. 63/637,758, filed on Apr. 23, 2024.

(51) Int. Cl. H01Q 15/16; H01Q 3/24

(52) U.S. Cl. CPC H01Q 15/16; H01Q 3/24

(57) ABSTRACT

An optical switching element provides light to a selected output port. A first set of optical antenna elements are optically coupled to respective output ports and distributed along a first axis. A second set of optical antenna elements are separated from a different respective optical antenna element in the first set along at least one of the first axis or a second axis perpendicular to the first axis. An optical element has a first surface that: is positioned to relay optical waves from each of the optical antenna elements in the first set to a target region, and to relay optical waves from the target region to each of the optical antenna elements in the second set, intersects a plane perpendicular to the second axis along a curved line, and intersects a plane perpendicular to the first axis along a straight line that is substantially parallel to the second axis.

### CROSS-REFERENCE TO RELATED APPLICATION(S)

This application claims the benefit of and priority to U.S. Provisional Application Ser. No. 63/637,758, entitled “MANAGING OPTICAL ANTENNA ELEMENT COUPLING FOR OPTICAL WAVES TRANSMITTED TO AND RECEIVED FROM A TARGET REGION,” filed Apr. 23, 2024, which is incorporated herein by reference.

### TECHNICAL FIELD

This disclosure relates to managing optical antenna element coupling for optical waves transmitted to and received from a target region.

### BACKGROUND

Some light detection and ranging (LiDAR) systems optimize various aspects of the LiDAR configuration based on different criteria. In some LiDAR configurations, an optical wave is transmitted from an optical source to target object(s) at a given distance and the light backscattered from the target object(s) is collected. By comparing properties of the backscattered light and those of the initial optical source, characteristics of the target objects, such as its relative distance and speed from the optical source, can be determined. Some LiDAR systems utilize an optical phased array (OPA) with a linear distribution of emitter elements (also called emitters or antennas) to transmit optical waves in the free space to target objects. Steering about a first axis perpendicular to the linear distribution can be provided by changing the relative phase shifts in phase shifters feeding each of the emitter elements. Other techniques can be used for steering about a second axis orthogonal to the first axis. The optical source used in such a system is typically a laser, which provides one or more optical waves, each with wavelengths falling in a particular range (e.g., between about 100 nm to about 1 mm, or some subrange thereof), also referred to herein as simply “light.”

### SUMMARY

In one aspect, in general, an apparatus for managing optical waves transmitted to and received from a target region comprises: one or more photonic integrated circuits comprising: an optical switching element configured to provide light from at least one optical source to a selected output port of two or more output ports of the optical switching element based on a selection signal, a first set of two or more optical antenna elements optically coupled to respective output ports of the optical switching element and distributed along a first axis, and a second set of two or more optical antenna elements arranged such that each optical antenna element in the second set is separated from a different respective optical antenna element in the first set along at least one of the first axis or a second axis perpendicular to the first axis, where each optical antenna element in the second set is positioned with respect to a different respective optical antenna element in the first set within a distance along the first axis that is less than a minimum distance along the first axis between any two different optical antenna elements in the first set; and at least one optical element that has a first surface that: is separated from the one or more photonic integrated circuits along a third axis perpendicular both the first axis and the second axis, is positioned to relay optical waves from each of the optical antenna elements in the first set to the target region, and to relay optical waves from the target region to each of the optical antenna elements in the second set, intersects a plane perpendicular to the second axis along a first curved line, and intersects a plane perpendicular to the first axis along a first straight line that is substantially parallel to the second axis.

Aspects can include one or more of the following features.

The first surface is configured to relay the optical waves from each of the optical antenna elements in the first set by reflection from an at least partially reflective portion of the first surface.

The at least partially reflective portion of the first surface has an optical reflectivity of at least 80% over a range of wavelengths that includes wavelengths of the relayed optical waves.

The at least partially reflective portion of the first surface is concave with respect to a side of the first surface upon which the relayed optical waves are incident when being reflected.

Each optical antenna element in the second set is separated from a different respective optical antenna element in the first set along the second axis.

Each optical antenna element in the first set comprises a respective grating antenna that comprises: a respective optical waveguide having a propagation axis, and a plurality of grating elements distributed along the propagation axis of the respective optical waveguide; and each optical antenna element in the second set comprises a respective grating antenna that comprises: a respective optical waveguide having a propagation axis, and a plurality of grating elements distributed along the propagation axis of the respective optical waveguide.

The second set of two or more optical antenna elements are arranged such that each optical antenna element in the second set is aligned with a different respective optical antenna element in the first set such that their respective propagation axes are substantially parallel to each other.

The apparatus further comprises a third set of two or more optical antenna elements arranged such that each optical antenna element in the third set is separated from a different respective optical antenna element in the second set along the second axis.

Each optical antenna element in the third set comprises a grating antenna that comprises: a respective optical waveguide having a propagation axis, and a plurality of grating elements distributed along the propagation axis of the respective optical waveguide.

The third set of two or more optical antenna elements are arranged such that each optical antenna element in the third set is aligned with a different respective optical antenna element in the second set such that their respective propagation axes are substantially parallel to each other.

The respective waveguide of each optical antenna element in the first set has a length along its propagation axis no longer than L, and the respective waveguide of each optical antenna element in the second set and the third set has a length along its propagation axis no longer than 2L.

The apparatus further comprises the optical source configured to change a wavelength of the light provided to the optical switching element to steer an optical wave emitted from an optical antenna element in the first set incident on the first surface along a portion of the first straight line that is substantially parallel to the second axis.

The first set of two or more optical antenna elements comprises four or more optical antenna elements, including a first subset of two or more optical antenna elements, each optical antenna element of the first subset having a first pitch of grating elements distributed along the propagation axis of the optical waveguide, and a second subset of two or more optical antenna elements, each optical antenna element of the second subset having a second pitch of grating elements distributed along the propagation axis of the optical waveguide, where the second pitch is different from the first pitch.

Each optical antenna element in the second subset is in proximity to a different respective optical antenna element in the first subset within a distance along the first axis that is less than a minimum distance along the first axis between any two different optical antenna elements in the first subset.

The optical switching element comprises: an optical distribution network configured to distribute light from the optical source to a plurality of waveguides, a plurality of phase shifters, each phase shifter configured to impose a respective phase shift on light propagating in a different respective waveguide of the plurality of waveguides, where at least some of the imposed phase shifts are dependent on the selection signal, and a slab that is at least partially optically transmissive configured to propagate light that has been phase shifted by the plurality of phase shifters to constructively interfere at a selected output port of the two or more output ports of the optical switching element based on the dependence of the imposed phase shifts on the selection signal.

The at least one optical element comprises a first optical element and a second optical element, where the first surface is a first surface of the first optical element, and the second optical element has a second surface that: is closer to the one or more photonic integrated circuits along the third axis than the first surface of the first optical element, is positioned along with the first surface of the first optical element to relay optical waves from each of the optical antenna elements in the first set to the target region, and to relay optical waves from the target region to each of the optical antenna elements in the second set, intersects the plane perpendicular to the second axis along a second curved line with different curvature than the first curved line, and intersects the plane perpendicular to the first axis along a second straight line that is substantially parallel to the second axis.

Each optical antenna element in the second set is optically coupled to a phase-sensitive detector that is optically coupled to a local oscillator optical wave for coherent detection of optical waves relayed from the target region.

The local oscillator optical wave optically coupled to each phase-sensitive detector is provided from an optical wave that propagates out of a portion of a different respective optical antenna element in the first set.

The apparatus further comprises electronic circuitry configured to perform light detection and ranging (LiDAR) to estimate a distance to a portion of the target region based at least in part on coherent detection of the optical waves relayed from the target region.

In another aspect, in general, a method for fabricating a device for managing optical waves transmitted to and received from a target region comprises: forming one or more photonic integrated circuits comprising: an optical switching element configured to provide light from at least one optical source to a selected output port of two or more output ports of the optical switching element based on a selection signal, a first set of two or more optical antenna elements optically coupled to respective output ports of the optical switching element and distributed along a first axis, and a second set of two or more optical antenna elements arranged such that each optical antenna element in the second set is separated from a different respective optical antenna element in the first set along at least one of the first axis or a second axis perpendicular to the first axis, where each optical antenna element in the second set is positioned with respect to a different respective optical antenna element in the first set within a distance along the first axis that is less than a minimum distance along the first axis between any two different optical antenna elements in the first set; and forming at least one optical element that has a first surface that: is separated from the one or more photonic integrated circuits along a third axis perpendicular both the first axis and the second axis, is positioned to relay optical waves from each of the optical antenna elements in the first set to the target region, and to relay optical waves from the target region to each of the optical antenna elements in the second set, intersects a plane perpendicular to the second axis along a first curved line, and intersects a plane perpendicular to the first axis along a first straight line that is substantially parallel to the second axis.

In another aspect, in general, a method for managing optical waves transmitted to and received from a target region comprises: from one or more photonic integrated circuits: providing light using an optical switching element from at least one optical source to a selected output port of two or more output ports of the optical switching element based on a selection signal, transmitting light from a first set of two or more optical antenna elements optically coupled to respective output ports of the optical switching element and distributed along a first axis, and receiving light into a second set of two or more optical antenna elements arranged such that each optical antenna element in the second set is separated from a different respective optical antenna element in the first set along at least one of the first axis or a second axis perpendicular to the first axis, where each optical antenna element in the second set is positioned with respect to a different respective optical antenna element in the first set within a distance along the first axis that is less than a minimum distance along the first axis between any two different optical antenna elements in the first set; and relaying light using at least one optical element that has a first surface that: is separated from the one or more photonic integrated circuits along a third axis perpendicular both the first axis and the second axis, is positioned to relay optical waves from each of the optical antenna elements in the first set to the target region, and to relay optical waves from the target region to each of the optical antenna elements in the second set, intersects a plane perpendicular to the second axis along a first curved line, and intersects a plane perpendicular to the first axis along a first straight line that is substantially parallel to the second axis.

Aspects can have one or more of the following advantages.

An optical transceiver system that can be included in a LiDAR system can use a combination of an optical switching element, separate sets of optical antenna elements (also referred to as transmit antennas and receive antennas), and at least one optical element, which together enable management of optical waves transmitted to and received from a target region (e.g., a target region associated with a field of view of the LiDAR system). Some implementations of the switching element use an optical phased array coupled to a slab to implement a switch that routes light to specified transmit antennas. The transmit antennas emit the light into the optical element, which maps light emitted from different antennas to different angles in the field of view. Light that propagates back to the system after being scattered from a target passes through the optical element and is focused onto specific receive antennas in an array of receive antennas. In some implementations, each receive antenna is directly coupled to a photonic in-phase/quadrature phase (I/Q or referred to hereafter as IQ) detector (i.e., without passing through another switching element like the one used for transmitting light) residing in an array of IQ detectors coupled to an array of electrical amplifiers. The steering mechanism discussed above can be combined with a wavelength sweep to enable two-axis beam steering. Further techniques for improving system performance include using parallelism (e.g., scanning multiple points in the field of view simultaneously) and methods for expanding the field of view.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an example of a LiDAR system comprising an optical switching element and an external optical element.

FIG. 2 is a schematic diagram of an example of a LiDAR system.

FIG. 3A is a schematic diagram of an example of an optical switched array.

FIG. 3B is a schematic diagram of an example of an optical switched array system with a focusing element.

FIG. 3C is a schematic diagram of an example of an optical switched array.

FIG. 3D is a schematic diagram of an example of an optical phased array.

FIG. 3E is a schematic diagram of an example of an optical switched array.

FIG. 4 is a schematic diagram of an example of a grating-antenna-based optical phased array.

FIG. 5 is a schematic diagram of an example system for angular steering with an external optical element.

FIG. 6A is a schematic diagram of an example of angular steering with an external optical element and grating antennas.

FIG. 6B is a schematic diagram of an example of angular steering with an external optical element.

FIG. 6C is a schematic diagram of an example of angular steering with an external optical element.

FIG. 6D is a schematic diagram of an example of angular steering with an external optical element and a grating antenna.

FIG. 7 is a schematic diagram of an example of angular steering with an external optical element for transmit and receive operation.

FIG. 8 is a schematic diagram of an example of an optical antenna array.

FIG. 9 is a schematic diagram of an example of an optical switching device.

FIG. 10 is a schematic diagram of an example of a system for angular steering with external optical elements.

FIG. 11A is a schematic diagram of an example of angular steering with external optical elements and grating antennas.

FIG. 11B is a schematic diagram of an example of angular steering with external optical elements.

FIG. 11C is a schematic diagram of an example of angular steering with external optical elements and grating antennas.

FIG. 11D is a schematic diagram of an example of angular steering with external optical elements.

FIG. 12 is a schematic diagram of an example of an optical antenna array comprising multiple receiver antenna arrays.

FIG. 13 is a schematic diagram of an example of optical antenna array comprising multiple optical antenna arrays.

FIG. 14 is a schematic diagram of an example of an optical antenna array comprising multiple optical grating types.

### DETAILED DESCRIPTION

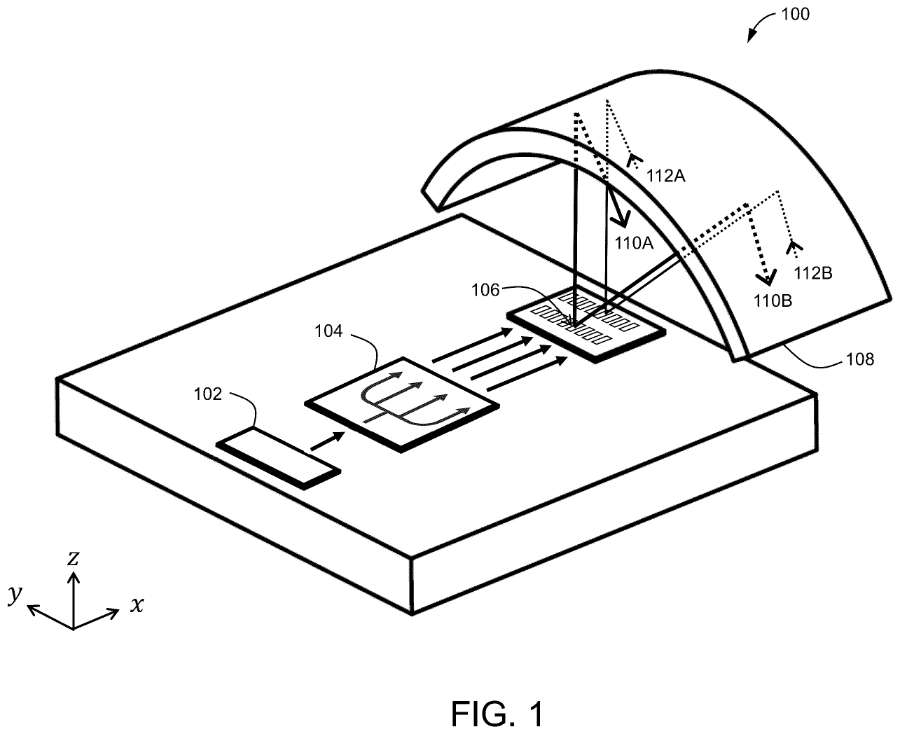

Referring to FIG. 1, an example optical transceiver system 100, i.e., an apparatus for managing optical waves transmitted to and received from a target region, can include an optical source 102 that is coupled into a photonic integrated circuit. This photonic integrated circuit can comprise an optical switching element 104 that directs light into one or more output channels and then to an array comprising one or more optical antenna elements 106. These antenna elements can transmit the optical beam into free space, where it can interact with one or more external optical elements 108 that can guide the angular properties of the beam, which is shown in FIG. 1 expanding from a selected one of the optical antenna elements 106 between beam edges 110A and 110B. Backscattered optical radiation from a target object or area from a given direction, show in FIG. 1 between optical rays 112A and 112B, can be directed with the one or more external optical elements 108 onto a corresponding one of the optical antenna elements with a corresponding position in the array, as described in more detail below. The optical switching element 104 and optical antenna elements 106 can be integrated onto the same photonic chip or can be fabricated on separate photonic chips that are then optically coupled together on a mount or on another photonic integrated circuit. In some implementations, the examples described herein may be designed to operate over a predetermined range of optical wavelengths such as, for example, the λ=1500 to 1600 nm band or the λ=1270 to 1330 nm band.

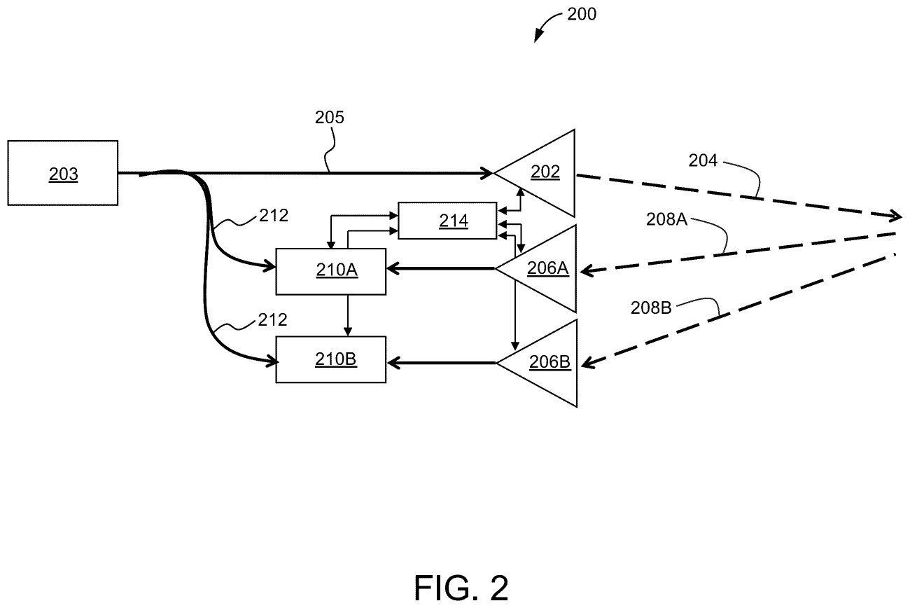

FIG. 2 shows an example of a LiDAR system 200 in which the optical transceiver system shown in FIG. 1 can be used. The LiDAR system 200 uses a configuration that can include one or more transmitter (TX) antenna modules and one or more receiver (RX) antenna modules. For example, some implementations are configured to use separate TX and RX antenna modules, where the separate antenna modules provide a separate transmitting aperture and receiving aperture (i.e., in a bistatic arrangement). In other implementations, an antenna module can be configured to operate in both a transmitter (TX) mode of operation and a receiver (RX) mode of operation (i.e., in a monostatic arrangement) where the transmitting aperture and the receiving aperture are the same. In the example of FIG. 2, the LiDAR system 200 includes a transmitter antenna module 202 that transmits an optical beam 204 at an angle that can be steered over a steering range, and a first receiver antenna module 206A and a second receiver antenna module 206B that can each be controlled to receive light incoming from a particular angle (i.e., a multi-static arrangement). For example, the first receiver antenna module 206A can be configured to receive incoming light 208A including a portion of the optical beam 204 backscattered from a target object or region, and the second receiver antenna module 206B can be configured to receive incoming light 208B including a portion of the optical beam 204 backscattered from the target.

The LiDAR system 200 includes an optical source 203 that provides an optical wave 205 to the transmitter antenna module 202. In some implementations, the optical source 203 is a continuous wave (CW) coherent light source (e.g., a laser) that provides an optical wave that has a narrow linewidth and low phase noise, for example, sufficient to provide a temporal coherence length that is long enough to perform coherent detection over the time scales of interest. In some implementations, the optical source 203 is a frequency tunable laser system in which the frequency of the light provided can be swept to perform frequency modulated continuous wave (FMCW) LiDAR measurements. Coherent receiver modules 210A and 210B receiving collected light from the first receiver antenna module 206A and the second receiver antenna module 206B, respectively, are configured to coherently mix the collected light with light of a local oscillator (LO) 212, which can be derived from the optical source 203 or from a portion of the optical wave 205 provided to the transmitter antenna module 202. A photodetection system, such as a balanced detector or an in-phase/quadrature-phase (IQ) detector, can be used to obtain one or more electrical signals representing the strength of a beat signal that has a maximum amplitude when the frequency of the LO and the received light are substantially equal.

In some alternative examples of LiDAR systems, the optical source included in the LiDAR system is a coherent light source with a broad or narrow linewidth delivering an optical power within discrete pulses in time at some repetition rate. In this implementation, a photodetection system consisting of photodiodes or avalanche photodiodes coupled with a time-tagging system can be used to detect and resolve the incoming light, as well as the initial optical source, into electronic signals.

A control module 214 is configured to control various aspects of the antenna modules and coherent receiver modules to determine information about a target object associated with a detection event based at least in part on one or more characteristics of the received backscattered light. In addition to a location of a target object that has backscattered light, there may also be range information characterizing a distance to the target object, and/or velocity information characterizing a relative speed of the target object, that can be obtained based at least in part on a frequency chirp (e.g., a linear chirp) that is applied to the optical wave 205 generated by the optical source 203. The control module 214 can include electronic circuitry (e.g., application specific integrated circuit, and/or processor cores), and in some cases is integrated on the same photonic integrated circuit including the antenna modules or on an electronic integrated circuit mounted to the photonic integrated circuit including the antenna modules.

Any of a variety of techniques can be used to steer the transmission angle of the optical beam 204 provided by the transmitter antenna module 202 over a steering range, and to steer the reception angle of the first receiver antenna module 206A and the second receiver antenna module 206B. In some implementations, an OPA is used to enable steering of a lobe of a radiation intensity pattern (also referred to as a gain pattern) associated with the OPA. An OPA can also be used for other components of a system other than an antenna module, as described in one of the examples below.

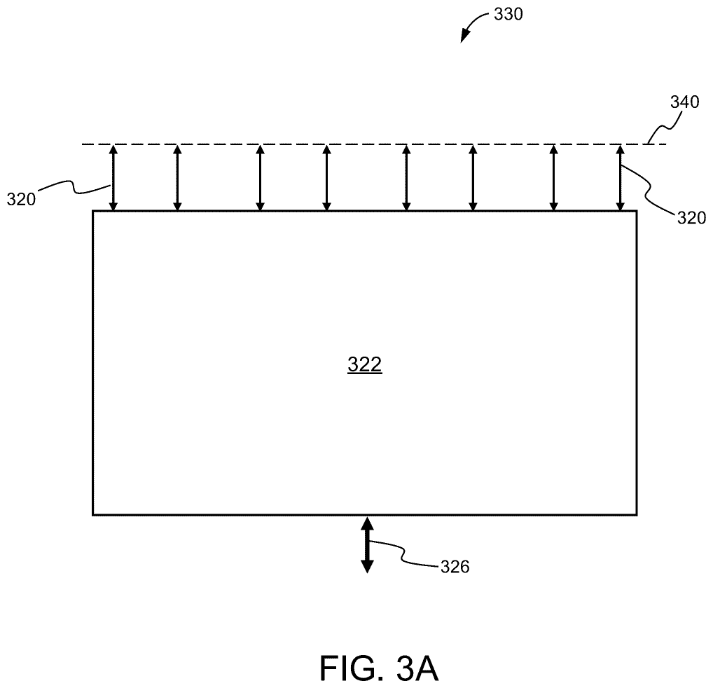

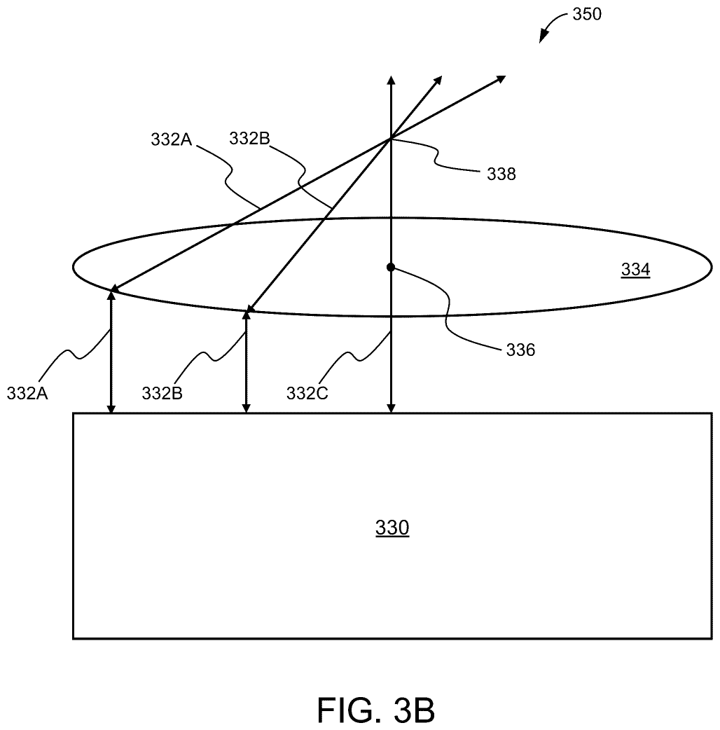

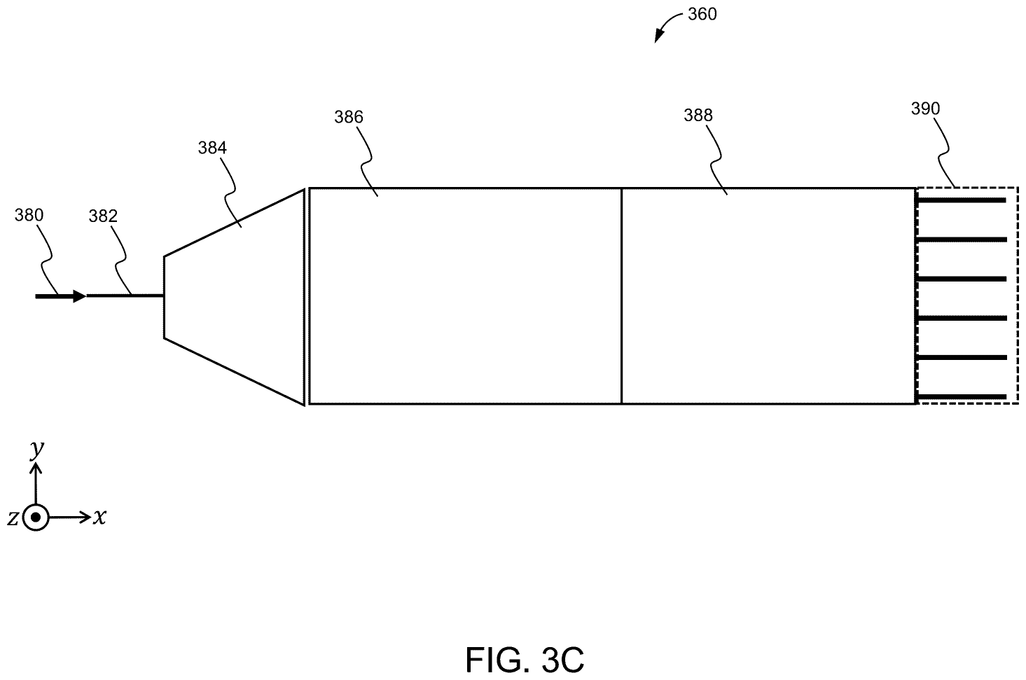

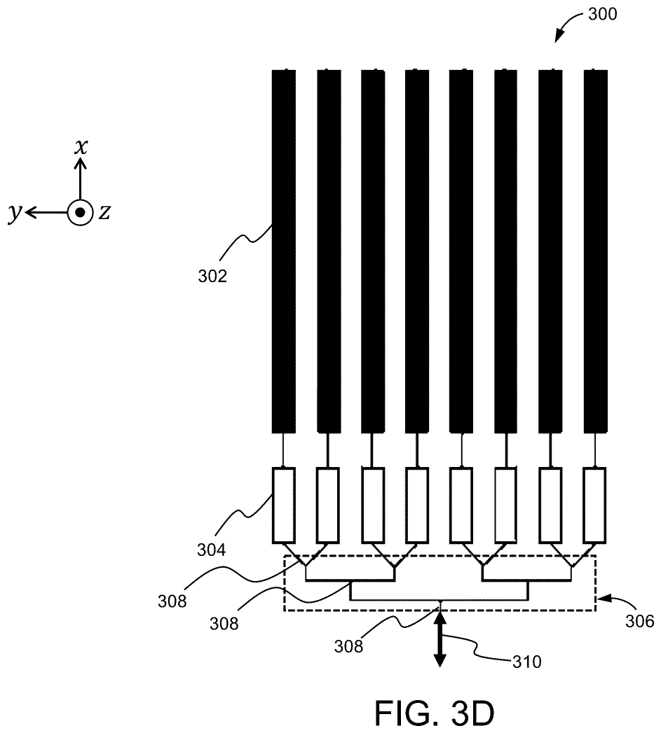

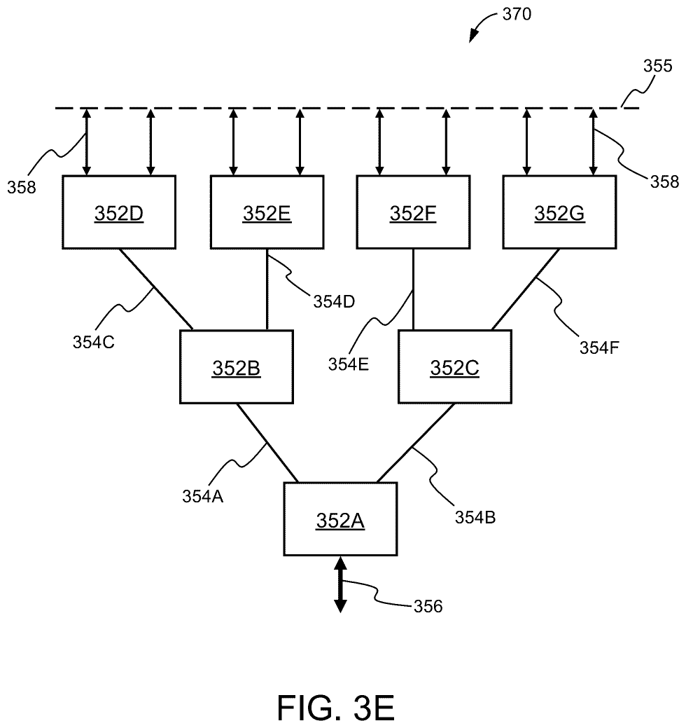

Another type of optical steering technique is based on an optical switched array. An example of an optical switched array 330 is depicted in FIG. 3A. In this example, the optical switched array 330 includes an optical switching module 322 that provides an optical path between an optical port 326 at one end and a particular selected optical port of an array of multiple optical ports 320 at the other end. In a transmit mode of operation, the optical switching module 322 directs an optical input at the optical port 326 to a selected optical port 320 such that optical output is distributed at a portion of a coupling plane 340. In a receive mode of operation, the optical switching module 322 can also receive an optical field from any point along the coupling plane 340 and direct the optical field to the optical port 326.

In some LiDAR system configurations, an external optical element such as a focusing element may be used to steer the light from the optical switched array system in one dimension. FIG. 3B shows an example optical switched array system 350 that performs 1D-beam-steering. The optical switched array system 350 comprises an optical switched array 330. The optical switched array 330 can selectively output a first optical beam 332A, a second optical beam 332B, or a third optical beam 332C at different spatial locations. While only three optical beams are shown in this example, some optical switched arrays can output a plurality of optical beams, each at a different respective spatial location. Each optical beam 332A-332C traverses a focusing element 334 (e.g., a transparent focusing element such as a lens) that converts a lateral displacement between the respective optical beam 332A-332C and a center of the focusing element 336 into an angular displacement. In this example, each optical beam 332A-332C passing through the focusing element 334 intersects at a point 338 (e.g., a focus of a lens). For example, the first optical beam 332A has a larger lateral displacement from the center of the focusing element 336 than the second optical beam 332B, resulting in the first optical beam 332A having a larger angular displacement with respect to its optical path prior to traversing the focusing element 334 than the second optical beam 332B. Since the third optical beam 332C is orthogonal to the surface of the focusing element 334 and has no lateral displacement from the center of the focusing element 336, the third optical beam 332C has no angular displacement.

The optical switched array system 350 depicted in FIG. 3B utilizes a focusing element 334 that is transparent in order to convert the lateral displacement between the optical beam and the center of the focusing element 336 into an angular displacement. In some configurations, this focusing element 334 can lead to undesired effects, such as aberrations, when the optical beam is steered in multiple dimensions. Alternatively, this focusing element 334 can be replaced with a reflective focusing element, such as in the configuration depicted in FIG. 1, to mitigate these effects.

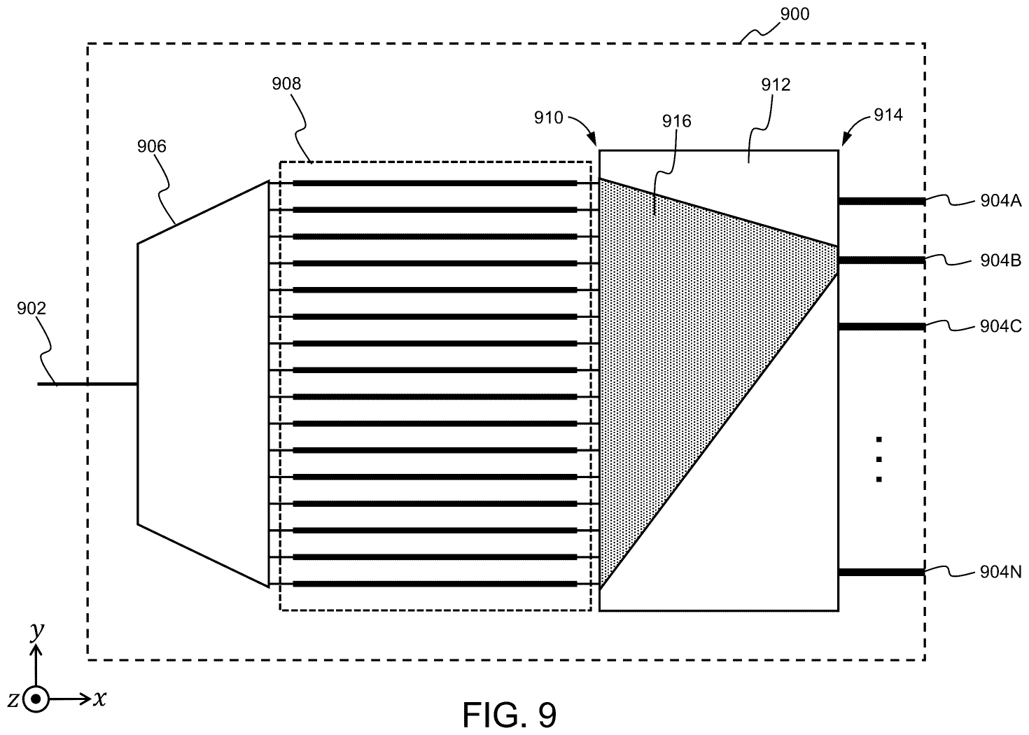

FIG. 3C shows an example of an optical switching element 360 that can be used to implement the optical switched array 330. Light 380 is input into a waveguide 382 that acts as an input port. The waveguide 382 connects to an optical distribution network 384 that distributes the optical power into an optical phased array (OPA) 386. Each waveguide from the output of the optical distribution network 384 feeds into an optical path that applies a respective phase shift. After propagating through the OPA 386, the light is injected into the input of an optical propagation component 388, which guides the light in the z-direction but allows it to diffract in the x- and y-directions. For example, the optical propagation component 388 could be an optically transmissive slab as in FIG. 9 below. The output of the optical propagation component 388 is connected to an array of output ports 390 distributed along the y-direction. By applying an appropriate actuation pattern to the phase shifters of the OPA 386, the light can be made to diffract through the slab such that it forms a localized spot at a specified y coordinate at the output of the optical propagation component 388.

Referring to FIG. 3D, alternative methods can be implemented to control the emission of the optical beam from an optical antenna 302 of an OPA 300. For example, light can be emitted from (and/or received into) one or more optical antennas 302 of an optical antenna array from different emission planes depending on the type of optical antennas being used. For an end-fire-antenna-based OPA, each optical antenna can be configured to emit light from the ends of the optical antennas at an emission plane that is perpendicular to the plane of the page in FIG. 3D (the y-z plane). The optical waves optically interfere with each other starting at the emission plane to form an optical phased array output beam. The direction of peak constructive interference depends on the relative phase shifts imposed on light entering the optical antennas 302.

Steering about a first axis perpendicular to the linear distribution of optical antennas 302 in OPA 300 can thus be provided by changing the relative phase shifts in phase shifters coupled to each of the optical antennas. The OPA 300 includes an array of optical phase shifters 304 that impose respective phase shifts on optical waves such that phase shifted optical waves enter the respective optical antennas 302 when the OPA is used as a transmitter (as in the OPA of the optical switching element 360), or on optical waves that have been collected by respective optical antennas 302 when the OPA is used as a receiver. The optical phase shifters 304 can be, for example, electro-optic, thermal, liquid crystal, pn junction phase shifters. In some examples, each of the optical phase shifters 304 is controlled independently, while in other examples two or more of the optical phase shifters 304 may be jointly controlled. An optical coupler 306 is configured to couple an optical port 310 to the array of optical phase shifters 304. In this example, the optical coupler 306 is in the form of a power splitting network formed from interconnected power splitters 308. In this example, the power splitters 308 are 1×2 power splitters (also referred to as 50/50 power splitters) and are interconnected by waveguides in a binary tree arrangement to achieve substantially equal power into each optical phase shifter 304 from an input optical wave entering the optical port 310 when the OPA 300 is used as a transmitter in TX operation, and to provide substantially equal path lengths between each optical phase shifter 304 and the optical port 310. When the OPA 300 is used as a receiver in RX operation, the light received by the optical antennas 302 and phase shifted by the optical phase shifters 304 is combined at each of the power splitters 308 into an output optical wave at the optical port 310, which can then be further manipulated, transformed, or measured.

An alternative implementation of an optical switched array 370, shown in FIG. 3E, is a tree-like structure comprising a plurality of optical switches 352A-352G optically interconnected via waveguides 354A-354F. In some examples, each optical switch of the plurality of optical switches 352A-352G can be Mach-Zehnder interferometers or another kind of optical switch. Each optical switch of the plurality of optical switches 352A-352G may be controlled in response to one or more applied voltages, allowing the plurality of optical switches 352A-352G to direct light from a first switch port to a second switch port and a third switch port in a tunable ratio (e.g., 50/50, 0/100, 25/75). By way of example, the optical switch 352B can direct light from waveguide 354A to waveguides 354C and 354D. Accordingly, the plurality of optical switches 352A-352G can be configured (e.g., by applied voltages) to open select optical pathways between an optical port 356 and the array of optical antennas 358. For example, by applying suitable (possibly time-varying) voltages, the optical switched array 370 can provide light (e.g., emitted from a laser) from the optical port 356 to one or more of the optical antennas of the array of optical antennas 358. In another example, by applying suitable voltages, the optical switched array 370 can provide light received by one or more of the optical antennas 358 to the optical port 356. In an example that uses an endfire configuration, light is transmitted from or received into the optical antennas 358 at facets distributed over an edge 355 along which the optical antennas 358 are arranged. In general, each optical switch of the plurality of optical switches 352A-352G may have slightly different voltage requirements for power switching between their switch ports. Furthermore, one or more optical switches of the plurality of optical switches 352A-352G may be electrically interconnected to allow for joint voltage control, possibly reducing the number of voltage sources used. Each optical switch of the plurality of optical switches 352A-352G shown in FIG. 3E are configured in a 1×2 (i.e, one port by two ports) arrangement, however, other arrangements (e.g., 1×3, 1×4, 2×2, or 2×3) and mixtures of arrangements may also be utilized. The one or more optical switch types in an optical switched array need not all be of the same type or of the same technology (e.g., thermo-optic or electro-optic switches). A portion or all of the optical switched array 370 may be formed as part of a PIC.

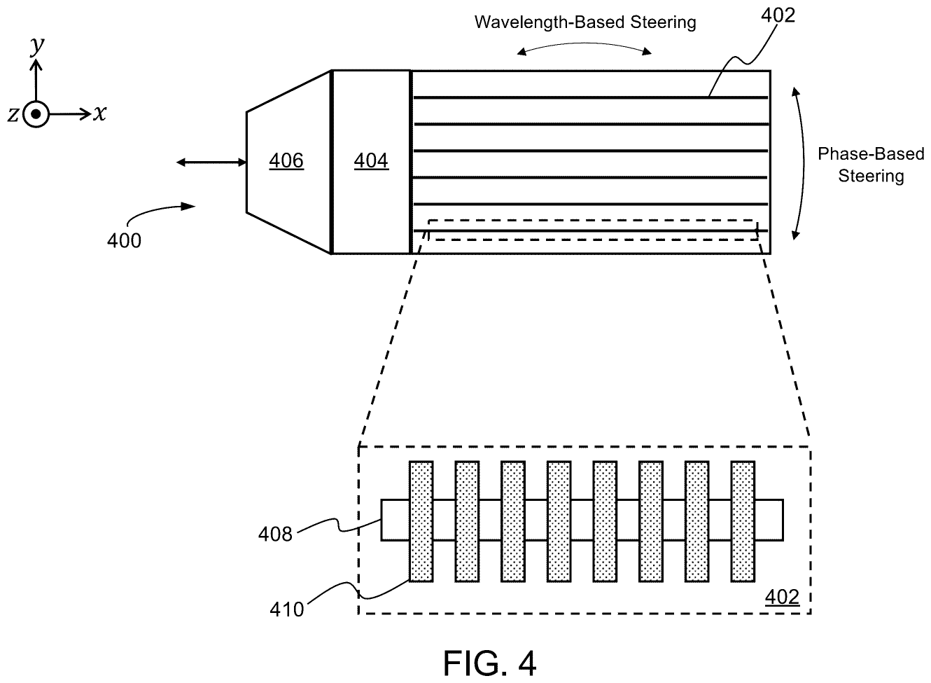

FIG. 4 shows an example of a grating-antenna-based OPA 400 that is configured for phase-based steering about the x-axis and wavelength-based steering about the y-axis. For example, when configured for TX operation, optical waves propagate along optical grating antennas 402 (along the x-axis), and light is perturbed and gradually emitted from various locations over the x-y emission plane. With this two-dimensional (2D) steering configuration, steering can be performed along transverse (e.g., polar and azimuth) angular directions in a polar coordinate system, with the steering in one angular direction being performed by phase shifters in a phase shifter (PS) module 404 and the steering in the other angular direction being performed by the wavelength of an optical wave distributing optical power via an optical coupler 406. The adjustment of the transmission angle for the TX operation and collection angle for the Rx operation in the phase-controlled angular direction can be dynamically performed as the phases imposed by the phase shifters in the PS module 404 can be quickly tuned. Each optical grating antenna 402 is formed from a waveguide 408 and grating elements 410 arranged periodically along the waveguide 408 with a particular pitch p1 (e.g., a constant spacing between grating elements 410) to perturb the guided optical wave causing emission in the direction of the grating elements 410. In other words, the grating elements 410 are distributed along the propagation axis of the waveguide 408 according to a pitch p1. The angle at which the light is emitted from each optical grating antenna 402 depends on a relationship between the pitch p1 and the wavelength, and thus can be steered by changing the wavelength. Such optical grating antennas can also be used in optical switched arrays, as described in more detail below.

The PS module 404 can also be configured to provide focusing. For example, the emitted light can have a nonlinear phase front imposed on it by the phase shifters in the PS module 404 for focusing in TX operation. This dynamically adjusted phase front can also tune the focal depth for Rx operation. Other techniques can be used for steering about a second axis orthogonal to the phase-based steering axis (e.g., mechanical based steering), such as when wavelength-based steering is not used for an optical grating antenna, or when an endfire optical antenna is used.

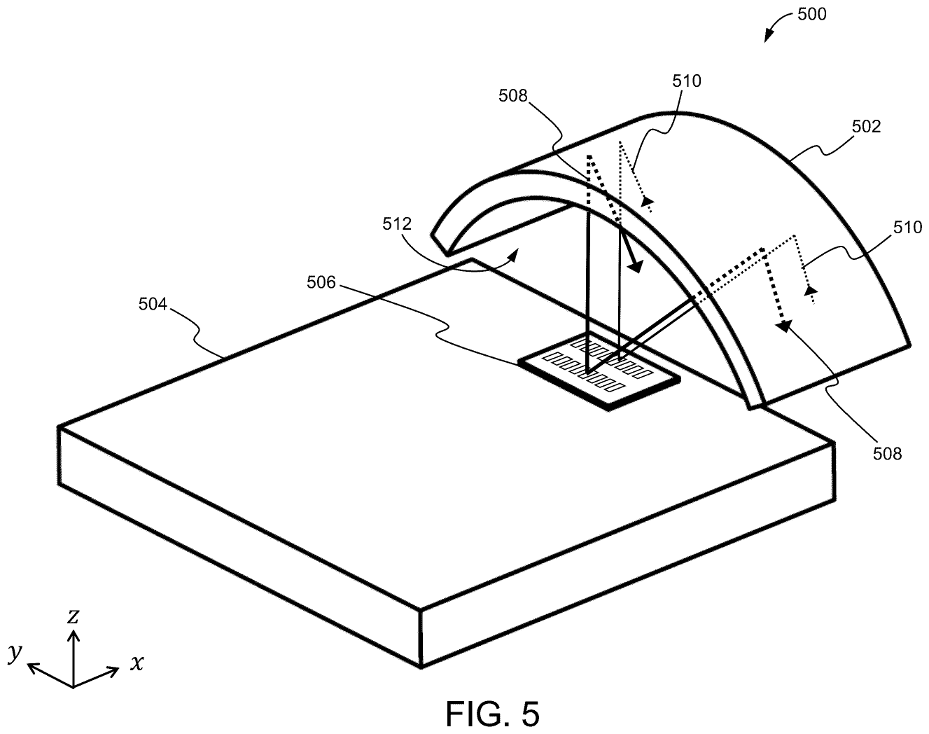

A perspective view of an example LiDAR system 500 that utilizes a reflective optical element 502 to steer the beam in one dimension is shown in FIG. 5. The LiDAR system 500 comprises a mount 504 supporting a photonic integrated circuit (PIC) 506. In this example, the PIC 506 comprises an optical antenna array. The optical antenna array comprises an array of transmit (TX) antennas arranged at different locations along the y-axis. By way of example, FIG. 5 depicts one of the transmit antennas of the array of transmit antennas transmitting optical rays of a transmitted beam 508. The PIC 506 also comprises an array of receive (RX) antennas that are similarly distributed along the y-axis, but where the array of receive antennas is displaced along the x-axis with respect to the array of transmit antennas. By way of example, FIG. 5 depicts one of the receive antennas of the array of receive antennas receiving optical rays of a received beam 510. In some configurations, the array of receive antennas can also be displaced from the transmit array at varying distances relative to both the x and the y axes. A reflective optical element 502 is positioned above the portion of the PIC 506 that comprises the optical antenna array so that the optical antenna array of the PIC 506 resides in the focal plane of the reflective optical element 502. In this example, the reflective optical element 502 is separated from the PIC 506 along the z-axis, which is perpendicular to both the x-axis and the y-axis. The reflective optical element 502 comprises a first surface 512 on the underside of the reflective optical element 502. The first surface 512 is configured to relay light or optical waves by reflection from an at least partially reflective portion of the first surface 512. The first surface 512 also has a curvature along the y-direction but is flat along the x-direction such that the first surface 512 can collimate light along y-axis while acting as a mirror without optical power along the x-axis. In other words, the first surface 512 of the reflective optical element 502 intersects a plane perpendicular to the x-axis along a curved line and intersects a plane perpendicular to the y-axis along a straight line that is substantially parallel to the x-axis. In some examples, the first surface 512 can also be referred to as “concave.” In other words, the first surface 512 is concave with respect to a side of the first surface 512 upon which the relayed optical waves are incident when being reflected. The use of a reflective optical element 502, sometimes referred to as a reflective optic, rather than a transmissive refractive optic can mitigate undesirable coupling between the x-and y-axes, which can lead to difficulties in resolving details about the target objects. As will be discussed in more detail below, the transmit beam can be steered along one direction by operating an optical switch, which can be implemented using an optical phased array, to select the specific transmit antenna used to emit the light. In some implementations, the receive antennas may not be connected to an optical switch and the receive signal can be processed by electronically selecting which signal from an array of detectors will be processed.

In some implementations, each receive antenna of the array of receive antennas can be arranged such that each receive antenna is separated from a different transmit antenna of the array of transmit antennas along at least one of the y-axis or the x-axis. In some examples, each receive antenna of the array of receive antennas can be positioned with respect to a different respective transmit antenna of the array of transmit antennas within a distance along the y-axis that is less than a minimum distance along the y-axis between any two different transmit antennas of the array of transmit antennas.

In some examples, the first surface 512 of the reflective optical element 502 can be described as “relaying” optical waves from one or more transmit antennas of the array of transmit antennas to a target region and from the target region to one or more receive antennas of the array of receive antennas. Alternatively, the first surface 512 can be described as relaying optical waves between the optical antennas and a target region. In some implementations, the at least partially reflective portion of the first surface 512 of the reflective optical element 502 can have an optical reflectivity of at least 80% over a range of wavelengths that include wavelengths of the optical waves relayed by the first surface 512.

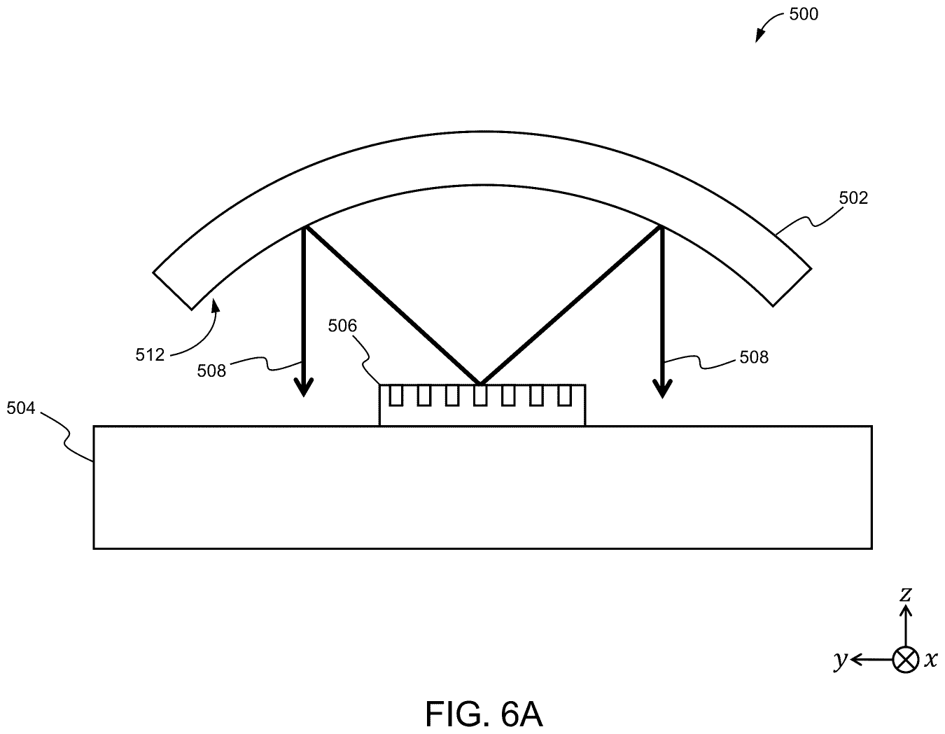

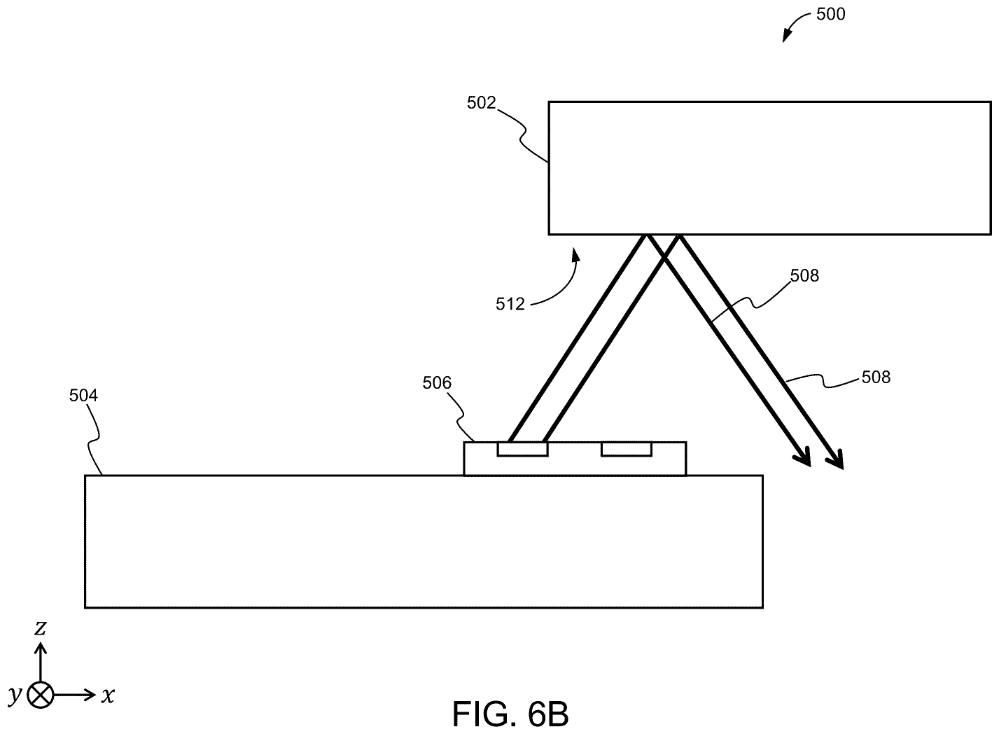

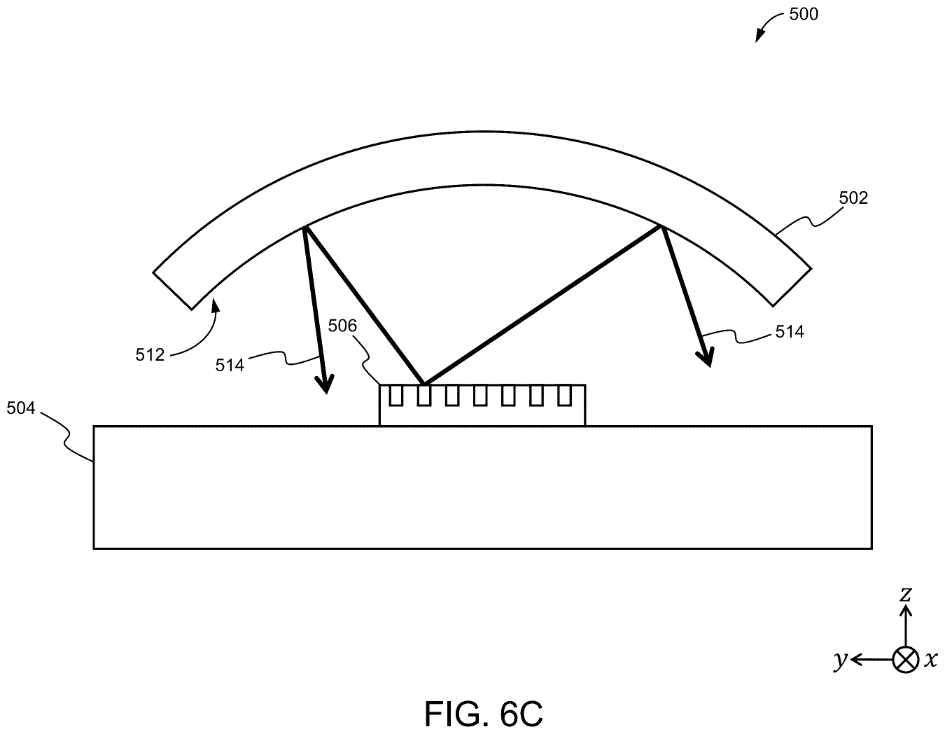

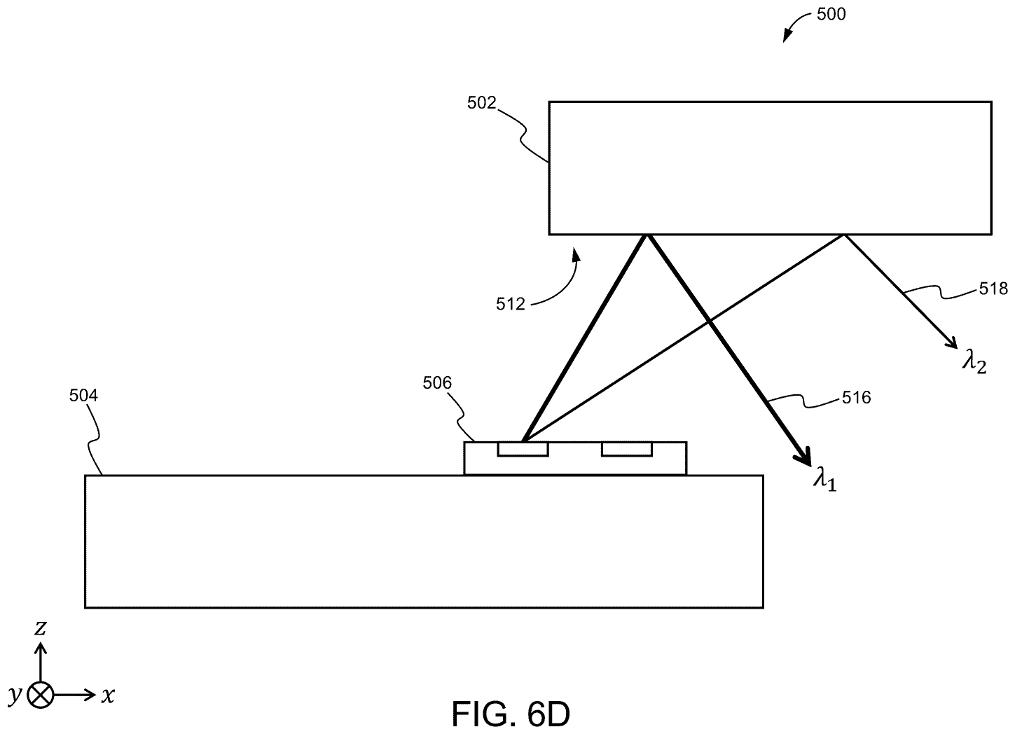

FIGS. 6A-6D depict two-dimensional (2D) views of the example LiDAR system 500 along different axes. As illustrated in FIG. 6A, the transmit antennas of the array of transmit antennas can designed to emit light that diverges with respect to the y-z plane (FIG. 6A) and that is substantially collimated with respect to the x-z plane (FIG. 6B). A transmitted beam 508 emitted by a transmit antenna can expand along the y-direction as it travels toward the reflective optical element 502. The first surface 512 of the reflective optical element 502 then reflects and collimates the transmitted beam 508. To ensure that the reflected beam can freely propagate without being obstructed by the mount 504, the transmit grating can be designed so that, when the emitted beam is viewed in the x-z plane, its propagation direction makes a non-zero angle with the z-axis that allows it to propagate past the PIC 506 and the mount 504 after being reflected by the reflective optical element 502, as shown in FIG. 6B. Referring now to the y-z plane, because the PIC 506 or the optical antenna array thereof resides in the focal plane of the reflective optical element 502, the direction of propagation of the collimated beam depends on the y-coordinate of the transmit antenna that emits the light. Because the different transmit antennas are located at different y-coordinates, the beam can be steered along a first axis, i.e., an axis parallel to the y-axis, by varying which transmit antenna is used to emit the light. By way of example, FIG. 6C depicts a beam 514 being emitted from a different transmit antenna than that of FIG. 6A. The transmit antenna used to emit the light can be selected using an optical switch whose design and functionality is discussed below. To steer the beam along a second axis, i.e., an axis that is parallel to the x-axis, the antennas can be designed to form a grating that is periodic along the x-direction so that sweeping the wavelength of the emitted light causes the beam to be steered in the x-z plane. This wavelength steering is illustrated in FIG. 6D, wherein a transmit antenna emits a first beam 516 having a first wavelength λ₂ and a second beam 518 having a second wavelength λ₂. Thus, by a combination of wavelength tuning and switching between transmit antennas, the transmit beam can be steered along two axes.

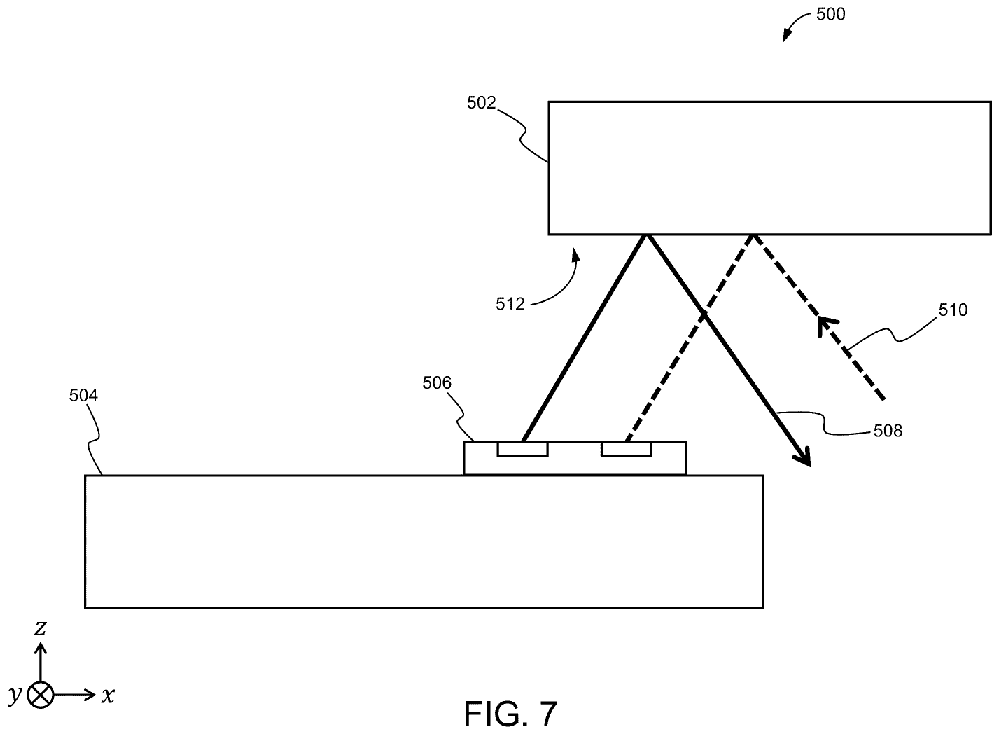

FIG. 7 depicts another 2D view of the example LiDAR system 500 transmitting a transmitted beam 508 and receiving a received beam 510. The array of receive antennas can be used to detect light that is scattered off a target illuminated by the transmitted beam 508. The received light, in this example received beam 510, propagates through the system in reverse and encounters the first surface 512 of the reflective optical element 502, which focuses the received beam 510 into a receive antenna on the PIC 506. When the target resides in the far-field, the received beam 510 arriving at the system can be propagating in a direction that is the reverse of the propagation direction of the transmitted beam 508 since the received beam 510 originates from an object illuminated by the target beam. Thus, the received beam 510 can be focused by the reflective optical element 502 into a receive antenna whose y-coordinate matches the y-coordinate of the corresponding transmit antenna that generated the transmitted beam 508. Similar to the transmit antennas, the receive antennas can be configured as gratings that are periodic along the x-axis and are designed to have the same angular dispersion with respect to wavelength as the transmit antennas. Thus, the received beam 510 can be absorbed by the receive antenna since it has the same wavelength as the transmitted beam 508 and originates from the same angle in the x-z plane as the transmitted beam 508. For targets located in the far-field, the fact that the x-coordinate of the receive antennas differs from the x-coordinate of the transmit antennas does not affect the absorption efficiency of the received light by the receive antennas since the propagation direction of the received light incident on the system matches the direction of the transmitted beam (i.e., they differ only by a sign). For targets residing at closer ranges, the received light can still be absorbed by the receive antenna, but the absorption efficiency can be decreased due to parallax.

The lengths of the TX and RX antennas can each be varied such that the optical power emission and coupling efficiencies are optimized as desired for a LiDAR system. However, the transmission and receiving performance can suffer if the antenna length is increased too much. For example, increasing TX antenna length can result in cancellation of the propagating optical field, resulting in lower transmission efficiencies. Shortening RX antenna length relative to TX antenna length can increase the coupling efficiency of the backscattered optical field. Shorter TX and RX antenna designs can also be produced with fewer fabrication errors.

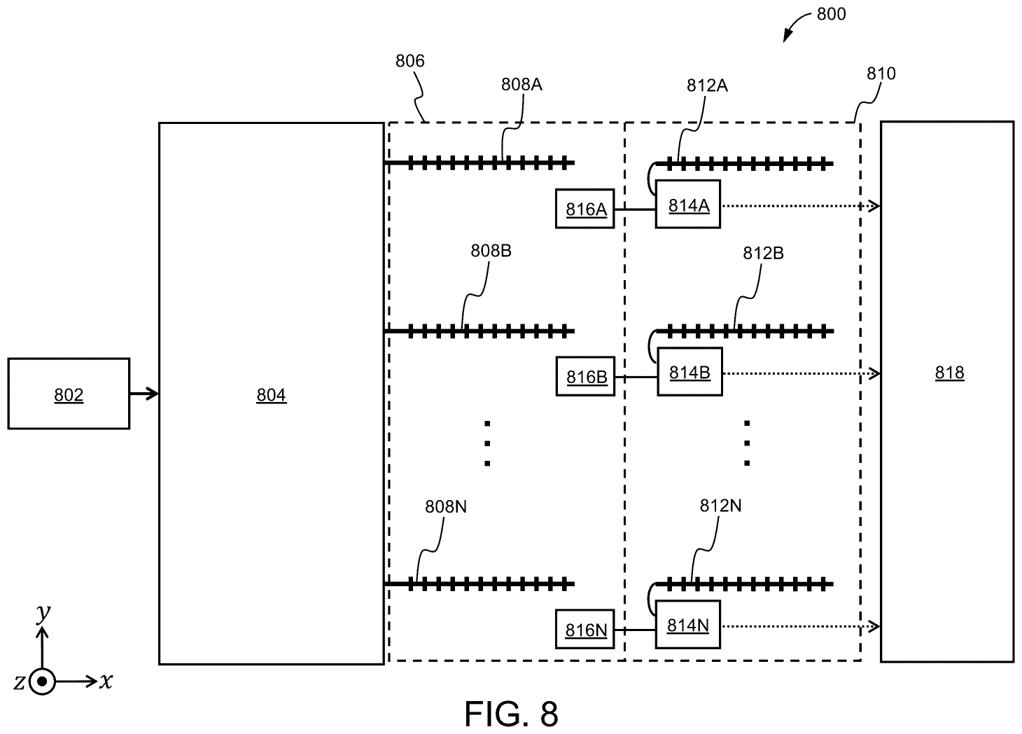

FIG. 8 shows an example PIC 800 that can be used in a LiDAR system. Light from a source laser 802 is fed into an optical switch 804 that has N output ports. In some examples, the source laser 802 can be integrated with the PIC 800 or located off-chip. The optical switch 804 can be actuated to route the light to any of the N output ports. The PIC 800 further comprises a TX antenna array 806 comprising a plurality of TX antennas 808A-808N. Each output port of the optical switch 804 feeds into a different respective TX antenna 808A-808N. The TX antennas 808A-808N are arranged along the y-axis to form the TX antenna array 806. Since the different TX antennas 808A-808N in the TX antenna array 806 are located at different y-coordinates, a transmit beam can be steered by actuating the switch to route light to a specified TX antenna 808A-808N, which then emits the light into an external optical element (not shown). The external optical element can map the y-coordinate at which the light was emitted to a corresponding outgoing beam angle, as described above and depicted in FIGS. 6A-6D. Adjacent to the TX antenna array 806 is an RX antenna array 810 comprising a plurality of RX antennas 812A-812N. Each RX antenna 812A-812N is positioned at the same set of y-coordinates as a different respective TX antenna 808A-808N, but are displaced along the x-axis relative to the TX antenna 808A-808N. In other words, each RX antenna 812A-812N is positioned with respect to a different respective TX antenna 808A-808N within a distance along the y-axis that is less than a minimum distance along the y-axis between any two different TX antennas 808A-808N. As described above, an RX antenna 812A-812N with a respective y-coordinate receives the return signal generated by the beam emitted from the corresponding TX antenna 808A-808N with the same y-coordinate. By way of example, the RX antenna 812B receives the return signal generated by the beam emitted from the TX antenna 808B. In some configurations, a phase-sensitive detector, such as an IQ detector, can be used to resolve the optical signal from an RX antenna 812A-812N. In this example, the output from each RX antenna 812A-812N is fed into one arm of a different respective IQ detector 814A-814N and light from a local oscillator (LO) 816A-816N is fed into the other arm of the IQ detector 814A-814N. In some implementations, each of the light from an LO 816A-816N can be sourced from the end of a respective TX antenna 808A-808N, i.e., the antenna end-fire power. In some implementations, each of the light from an LO 816A-816N can be extracted at the input port of a respective TX antenna 808A-808N using, for example, a directional coupler that extracts a given percentage of the optical power and diverts the percentage to be used as LO power. Since the input/end-fire of a given TX antenna 808A-808N can only contain substantial optical power when the switch is activated to route light to that TX antenna 808A-808N, light from an LO 816A-816N is provided only to the IQ detector(s) 814A-814N whose corresponding TX antenna 808A-808N is actively emitting. This method thus can avoid wasting optical power on inactive LO ports and eliminates an additional switch that would otherwise be used to route the LO power only to the active port(s).

The electrical signals from the IQ detectors 814A-814N are sent into an array of amplifiers 818 which can be, for example, transimpedance amplifiers. Each IQ detector 814A-814N can feed into a different respective amplifier of the array of amplifiers 818. For example, if a system comprises N IQ detectors 814A-814N, each of which outputs 2 electrical signals, then the array of amplifiers 818 could comprise 2N transimpedance amplifiers (not shown). The outputs (not shown) from the array of amplifiers 818 can be multiplexed into a smaller number of signals so that only signals associated with the active TX/RX antennas 808A-808N/812A-812N can undergo further processing. In some implementations, this signal processing can be used for extracting range and velocity information in an FMCW LiDAR system. In other words, a distance, i.e., a range, to at least a portion of a target region can be estimated based at least in part on coherent detection of optical waves relayed from the target region. In some examples, the signal processing can be performed by electronic circuitry.

Without using the methods described herein, the outputs from the RX antennas 812A-812N can alternatively be routed through an additional optical switch into a single IQ detector connected to an amplifier. However, such a system can be lossy due the additional optical switch. In contrast, using an array of IQ detectors 814A-814N and an array of amplifiers 818 as shown in FIG. 8 can avoid loss associated with the additional optical switch.

FIG. 9 shows an example optical switch 900 that can be implemented in a system such as the example shown in FIG. 8. The optical switch 900 comprises an input port 902 and a plurality of output ports 904A-904N. In some implementations, each of the input port 902 and output ports 904A-904N can comprise respective waveguides such that light can be coupled into and out of the waveguides. The waveguide of the input port 902 connects to an optical distribution network 906 that distributes the optical power into an array of waveguides 908. Each waveguide of the array of waveguides 908 comprises a respective phase shifter (shown by dark rectangles), which allows the phase of the light in each waveguide of the array of waveguides 908 to be independently controlled. After propagating through the phase shifters, the light in the array of waveguides 908 is injected into the input facet 910 of a slab 912. The slab 912 is at least partially transmissive so as to guide the light in the z-direction but allows the light to diffract in the x-and y-directions. For example, the slab 912 can comprise a uniform region of silicon or silicon nitride that extends over several millimeters in the x- and y-directions and is several hundreds of nanometers tall in the z-direction. The output facet 914 of the slab 912 is connected to the output ports 904A-904N which are distributed to form an array along the y direction. By applying an appropriate actuation pattern to the phase shifters of the array of waveguides 908, the light can be made to diffract through the slab 912 such that the light forms a localized spot at a specified y coordinate at the output facet 914 of the slab 912. In other words, the slab 912 propagates light that has been phase shifted to constructively interfere at a selected y-coordinate. By choosing this y-coordinate to match the y coordinate of one of the output ports 904A-904N, the light can be made to couple into that output port 904A-904N while not substantially coupling into the other output ports 904A-904N. By way of example, FIG. 9 shows light 916 coupling into the output port 904B.

In some implementations, the array of waveguides 908 can comprise M waveguides, where M is an integer that can differ from the number N of output ports 904A-904N associated with the optical switch 900. In some implementations, higher densities of M waveguides relative to the N output ports 904A-904N can result in better performance of the optical switch 900. In addition, the distribution of power among the M waveguides can be uniform or nonuniform. Nonuniform distributions such as a Gaussian distribution can result in better performance of the optical switch 900 (e.g., lower loss) compared to a uniform distribution because a nonuniform distribution can produce a formed spot, which is discussed below, that better matches the mode of an output waveguide into which it will ultimately couple.

In some examples, to increase the efficiency with which the formed spot couples to an output port 904A-904N, an interface coupler (not shown) can be added between the output facet 914 of the slab 912 and the output ports 904A-904N. For example, a taper can be used to convert the spot size to a mode that better matches the mode associated with the output port. In some cases, the coupling efficiency can also be improved by designing the slab 912 so that the output facet 914 traces a curved trajectory in the x-y plane.

The architecture of the optical switch 900 illustrated in FIG. 9 can be associated with several benefits. First, since the input power is distributed across the array of waveguides 908 prior to entering the phase shifters, the power propagating through each phase shifter can be low even when the total input power is high. This power distribution can enable the phase shifters to, for example, be implemented in silicon even when operating at high optical powers since the power in each individual phase shifter can be kept low enough that non-linear effects in silicon are negligible. This design contrasts with architectures that use a tree of switches where the majority of the optical power passes through a small number of waveguides that implement the phase shifters used to actuate the switches. Additionally, in the architecture depicted in FIG. 9, the light in any given waveguide of the array of waveguides 908 only passes through a single phase shifter. This design is in contrast to switch trees, where the light propagates through a series of switches, each of which contains phase shifters. Thus, the propagation loss introduced by the phase shifters can be limited to the maximum loss introduced by sending light through one phase shifter such that the loss does not add serially. This design can allow the optical switch 900 to be implemented with high-speed phase shifters that, for example, utilize the plasma dispersion effect in silicon, without introducing the compounding loss that would be present in an architecture that relies on a series of multiple high-speed switches, such as a high-speed switch tree. The fact that the phase shifters can be implemented using the plasma dispersion effect also means that they can be densely packed in the y direction. In contrast, thermal phase shifters can suffer from thermal crosstalk between neighboring phase shifters, which can limit the pitch at which the phase shifters can be packed. Dense packing of the phase shifters can allow the pitch of the array of waveguides that couples into the slab to be reduced, which in turn can reduce light lost in the slab to grating lobes. In some examples, grating lobes can be present due to the fact that a discrete lattice of waveguides is being used to inject light into the slab.

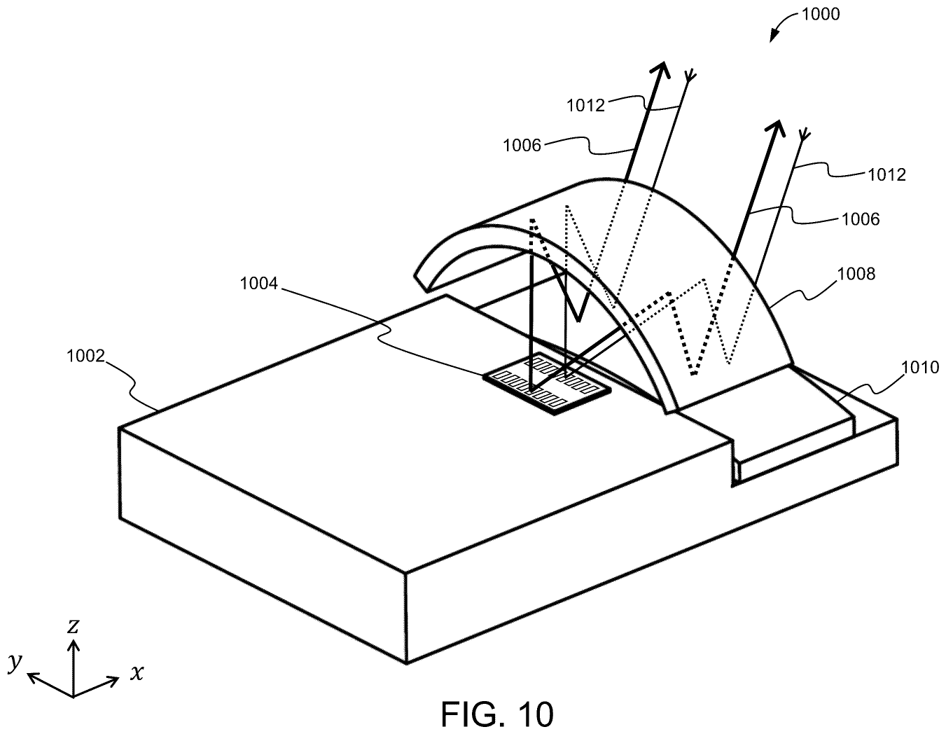

The configuration shown in FIG. 5 uses a single external optical element to collimate/steer the light. While this configuration can emit high-quality beams when steering near the central steering angle, beams emitted/received at other angles can contain aberrations. For instance, TX beams may not emerge from the optic collimated, and RX light may be deformed when focused by the optic onto the PIC. This effect can be mitigated by replacing the single external optical element with two or more external optical elements. A perspective view of an example system 1000 is shown in FIG. 10. The system 1000 comprises a mount 1002 supporting a PIC 1004. The PIC 1004 comprises an array of transmit antennas and an array of receive antennas. The system further comprises a first optical element 1008 and a second optical element 1010. In this example, the second optical element 1010 is supported by the mount 1002. The optical beam 1006 emitted from the PIC 1004 is first reflected off a surface of the first optical element 1008 and then off a surface of the second optical element 1010. In this example, the surface of the second optical element 1010 is positioned closer to the PIC 1004 along the z-axis than the surface of the first optical element 1008. Both the first optical element 1008 and the second optical element 1010 are reflective optics that are curved along the y-axis and are flat along the x-axis so that they can act as a powered element along one axis while acting as a mirror without optical power along the x-axis. In some examples, the first optical element 1008 can be described as having a “concave” reflective surface while the second optical element 1010 can be described as having a “convex” reflective surface. Along the axis with curvature, the first optical element 1008 may exhibit positive optical power, while the second optical element 1010 may exhibit negative optical power. The combined effect of the first optical element 1008 and the second optical element 1010 can be associated with benefits including, but not limited to, beam steering with reduced aberrations compared to the case with a single optical element. An optical beam 1012 can also be received by the system 1000 and be reflected off the second optical element 1010 and then the first optical element 1008.

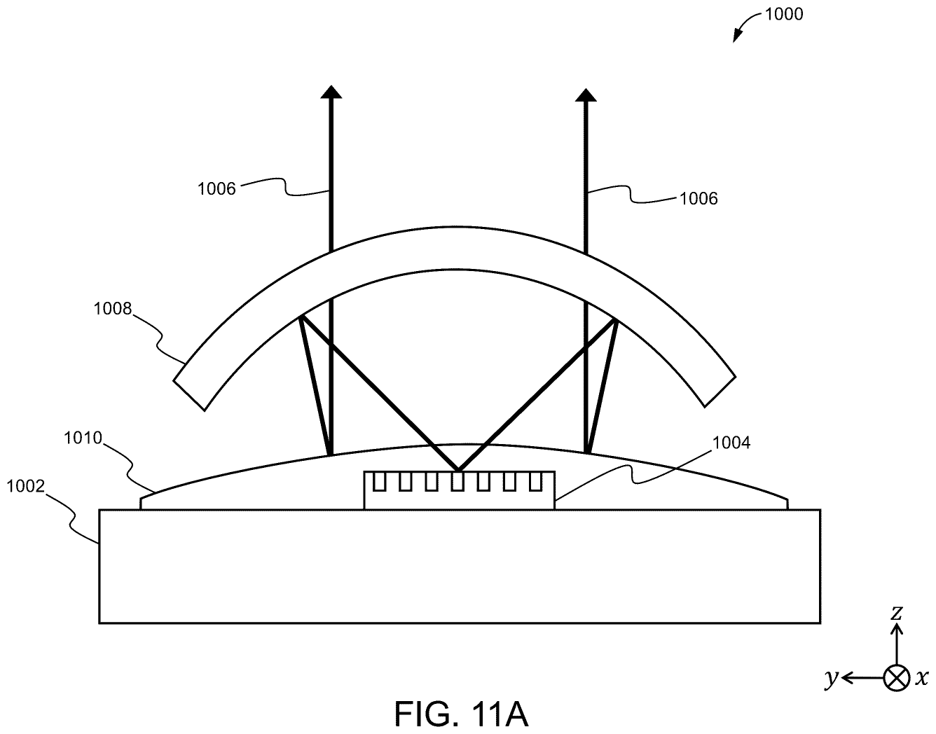

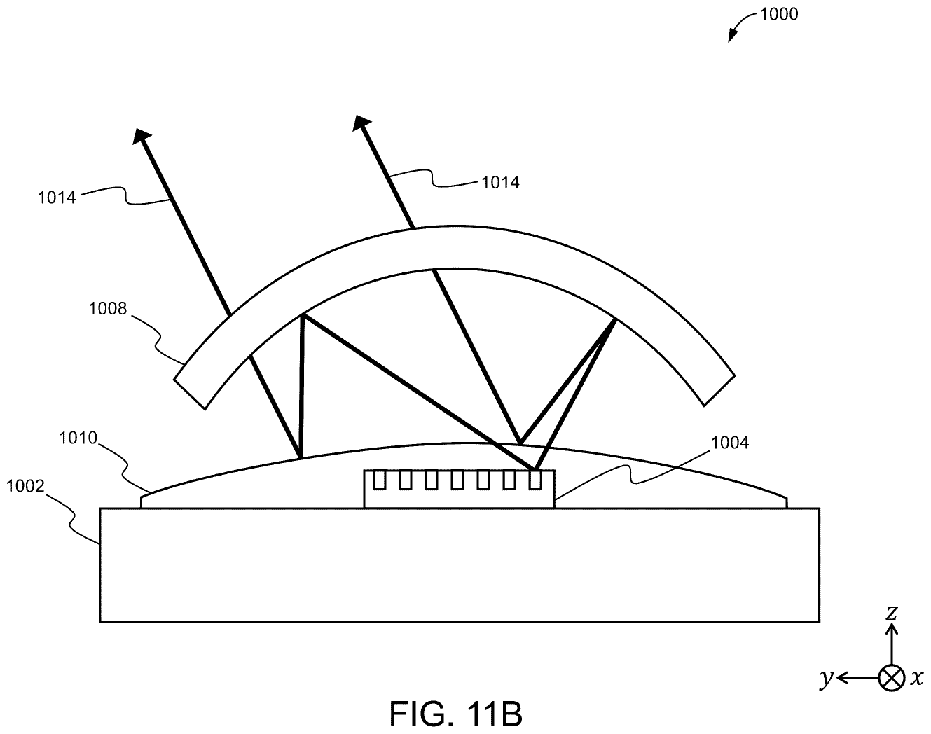

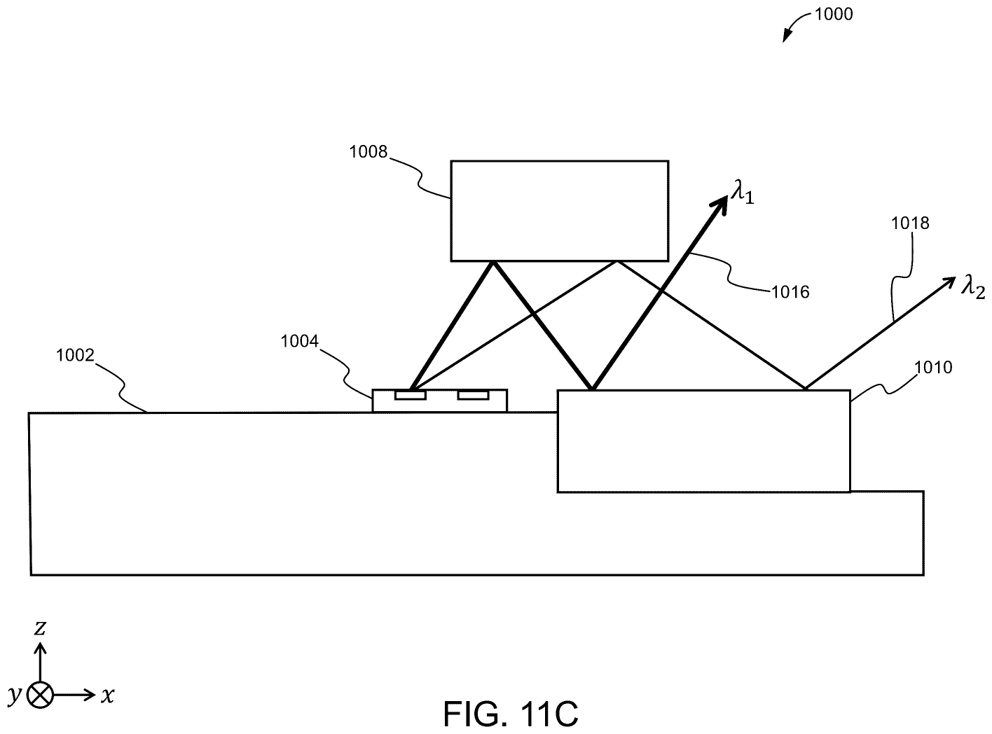

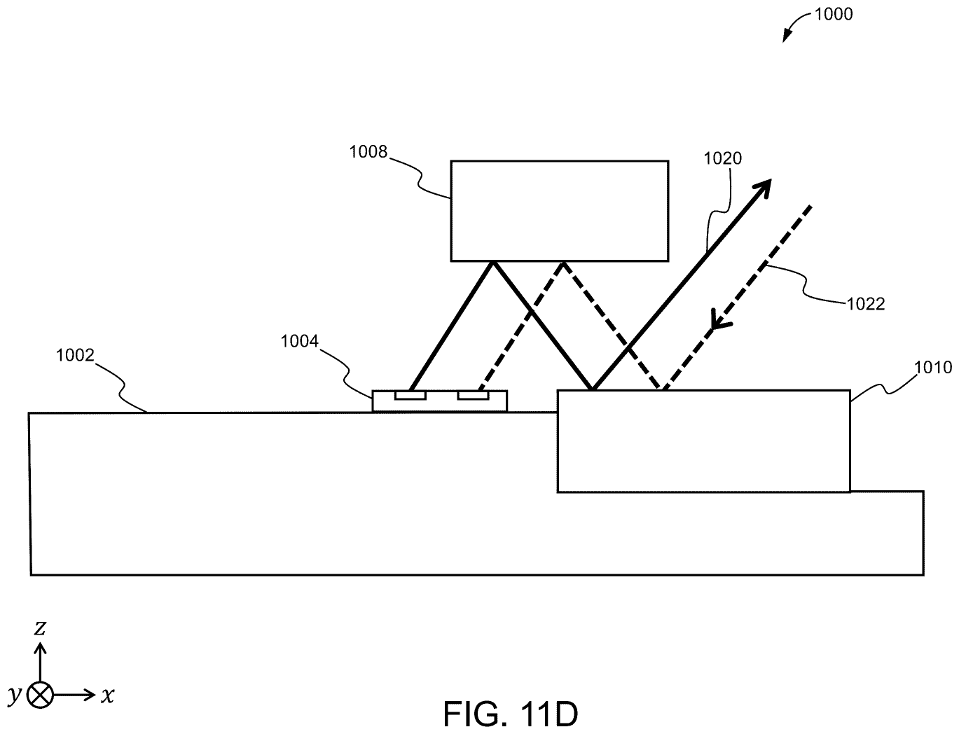

FIGS. 11A-11D depict 2D views of the system 1000 and illustrate how the system can emit, receive, and steer light. FIG. 11A shows the optical beam 1006 being emitted from the PIC 1004 by a TX antenna located in the center of the array of TX antennas along the y-axis. After being reflected by the first optical element 1008 and the second optical element 1010, the optical beam 1006 emerges as a collimated beam. By emitting from a TX antenna located at a chosen position along the y-axis, the propagation direction of the collimated beam can be controlled along one axis, as illustrated in FIG. 11B. By way of example, FIG. 11B depicts a beam 1014 being emitted from a different transmit antenna than that of FIG. 11A. By using two or more external optical elements instead of one, aberrations in the transmitted/received beams can be mitigated, amongst other benefits. Steering along the other axis can be achieved by varying the wavelength, which controls the angle in the x-z plane at which the antennas emit/receive. FIG. 11C illustrates this wavelength-based steering by showing the trajectories for a first beam 1016 having a wavelength Au and a second beam 1018 having a wavelength 22. FIG. 11D shows a view in the x-z plane of example paths followed by a TX beam 1020 and a RX beam 1022. The TX beam 1020 is emitted from a TX antenna in the array of TX antennas, and subsequently is reflected by the first optical element 1008 and the second optical element 1010 which collimate the beam (i.e., as illustrated in FIG. 11A). The RX beam 1022 passes through the system in reverse, first encountering the second optical element 1010 and then the first optical element 1008 that focus the RX beam 1022 onto the PIC 1004 where it is then absorbed by the RX antenna of the array of RX antennas, transferred into a waveguide, and routed into a detector (not shown).

The first optical element 1008 comprises a first surface that is separated from the PIC 1004 along the z-axis and is positioned to relay optical waves between optical antenna elements of the PIC 1004 and a target region. The first surface of the first optical element 1008 intersects a plane perpendicular to the x-axis along a first curved line, i.e., as shown in FIGS. 11A-11B. The first surface of the first optical element 1008 also intersects a plane that is perpendicular to the y-axis along a first straight line that is substantially parallel to the x-axis, i.e., as is depicted in FIGS. 11C-11D. The second optical element 1010 comprises a second surface that is positioned to relay optical waves between optical antenna elements of the PIC 1004 and a target region. The second surface of the second optical element 1010 intersects the plane perpendicular to the x-axis along a second curved line with a different curvature than the first curved line, i.e., as shown in FIGS. 11A-11B. The second surface of the second optical element 1010 also intersects the plane that is perpendicular to the y-axis along a second straight line that is substantially parallel to the x-axis, i.e., as is depicted in FIGS. 11C-11D.

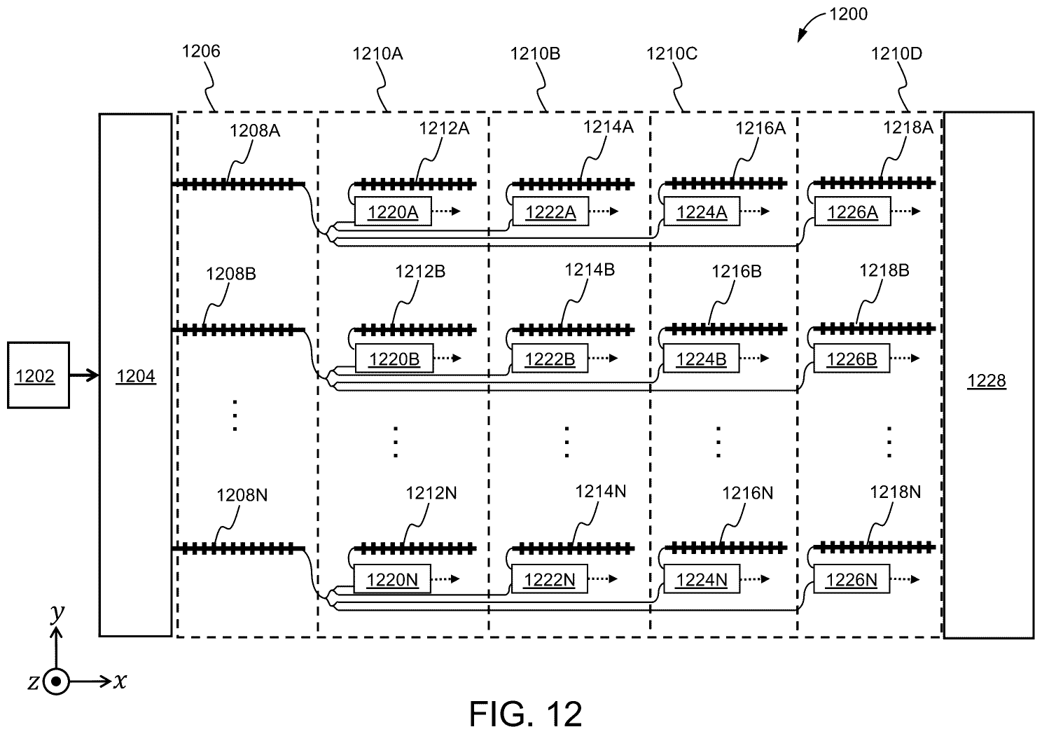

Some PICs can comprise multiple RX antenna arrays, where each antenna array is located at a different position along the x-axis. An example PIC 1200 is shown in FIG. 12. Light from a source laser 1202 is fed into an optical switch 1204 that has N output ports. In some examples, the source laser 1202 can be integrated with the PIC 1200 or located off-chip. The optical switch 1204 can be actuated to route the light to any of the N output ports. The PIC 1200 further comprises a TX antenna array 1206 comprising a plurality of TX antennas 1208A-1208N. Each output port of the optical switch 1204 feeds into a different respective TX antenna 1208A- 1208N. The TX antennas 1208A-1208N are arranged along the y-axis to form the TX antenna array 1206. The PIC 1200 further comprises a first RX antenna array 1210A comprising a plurality of RX antennas 1212A-1212N, a second RX antenna array 1210B comprising a plurality of RX antennas 1214A-1214N, a third RX antenna array 1210C comprising a plurality of RX antennas 1216A-1216N, and a fourth RX antenna array 1210D comprising a plurality of RX antennas 1218A-1218N. Each of the RX antennas of the first, second, third, and fourth RX antenna arrays 1210A-1210D can comprise similar configurations. Additionally, in this example, each of the RX antennas of the first, second, third, and fourth RX antenna arrays 1210A-1210D as well as each of the TX antennas of the TX antenna array 1206 are aligned such that their respective associated propagation axes are substantially parallel to each other. The output of each of the RX antennas of the first, second, third, and fourth RX antenna arrays 1210A-1210D are fed into respective IQ detectors 1220A-1220N, 1222A-1222N, 1224A-1224N, and 1226A-1226N. Each of the outputs of the IQ detectors 1220A-1220N, 1222A-1222N, 1224A-1224N, and 1226A-1226N are fed into an amplifier array 1228. While the example PIC 1200 comprises four RX antenna arrays, PIC configurations comprising any number of antenna arrays are also possible.

The PIC 1200 shown in FIG. 12 can operate similarly to the device shown in FIG. 8, except that the device in FIG. 12 captures receive light using the additional RX antenna arrays. This use of multiple RX arrays can be beneficial as TX light that scatters from a target and propagates back to the system can form a speckle pattern. Utilizing multiple RX antennas allows this speckle pattern to be statistically sampled at multiple spatial locations, which can be beneficial for increasing the probability that the system will detect light scattered from a target. In some implementations, the lengths of the RX antennas can be limited relative to the length L of the TX antennas. For example, RX antennas can be the same length L, or shorter than L, but in some cases not much longer than L (e.g., 2L or less) to avoid light that is uncorrelated from making a significant contribution to the sampling, which could reduce the resulting signal being received (or a signal-to-noise ratio of the signal).

In FIG. 12, the local oscillator power is sourced from the end-fire power of the actively emitting TX antenna, which is determined by setting the 1×N optical switch 1204 to route light to that TX antenna. This LO power is split and distributed to all RX antennas that reside at the same y coordinate as the actively emitting TX antenna. For instance, if the TX antenna 1208B is selected by the optical switch 1204, each RX antenna 1212B, 1214B, 1216B, and 1218B can receive LO power. This method can ensure LO power is routed only to the RX antennas that are currently in use given the state of the 1×N optical switch 1204, without requiring an additional switch to route the LO light. However, the LO power can also be sourced using different methods. For instance, LO power could be sampled from the waveguide at the interface between the switch output and the TX antenna input.

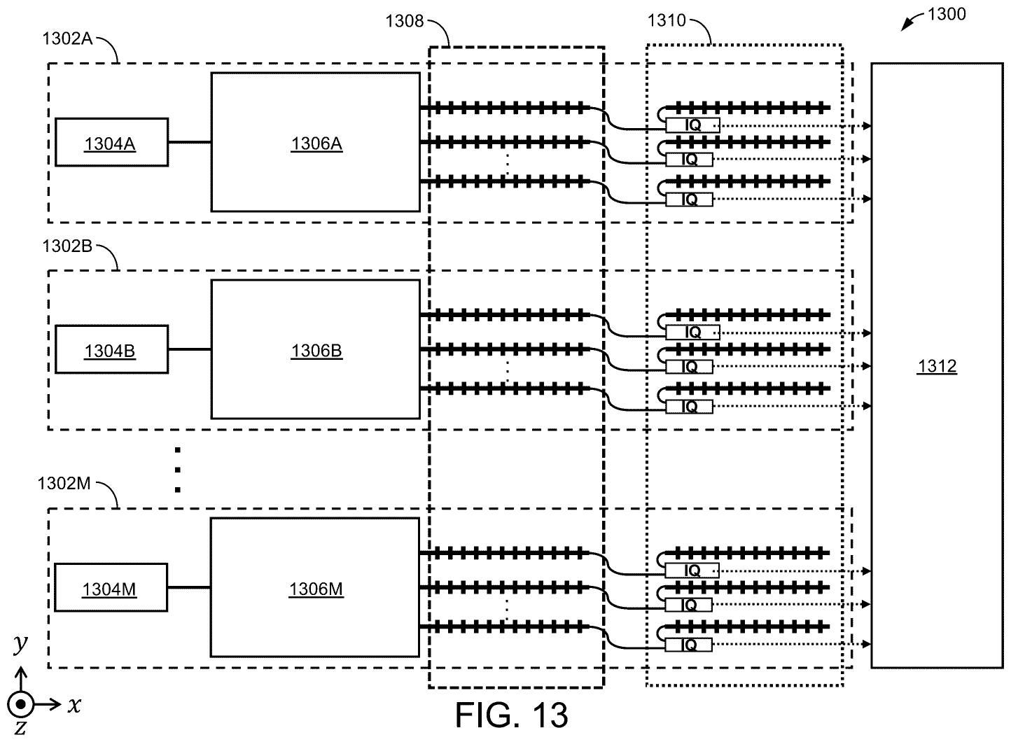

The architecture can also be modified to allow multiple points in the field of view to be simultaneously imaged by the LiDAR system. An example configuration of a PIC 1300 is illustrated in FIG. 13. The PIC 1300 comprises a plurality of subsystems 1302A-1302M. Each subsystem 1302A-1302M comprises a similar configuration to the system shown in FIG. 8. Each subsystem 1302A-1302M comprises a respective optical source 1304A-1304M connected to an optical switch 1306A-1306M. The output of each optical switch 1306A-1306M is connected to a respective plurality of TX antennas distributed along the y-axis. Each subsystem further comprises a respective plurality of RX antennas distributed along the y-axis and offset from the TX antennas along the x-axis. Together, the TX antennas form an array of TX antennas 1308 and the RX antennas form an array of RX antennas 1310. As before, the array of TX antennas 1308 are distributed along the y-direction and each TX antenna corresponds to an RX antenna in the array of RX antennas 1310 distributed along the y-direction. In other words, each RX antenna is paired with a corresponding TX antenna by virtue of both antennas residing at the same y-coordinate. The output of each RX antenna is connected to a respective IQ detector which is configured to provide output to an amplifier array 1312.

In some implementations, each optical switch 1306A-1306M can be configured using the architecture shown in FIG. 9. In some examples, the optical sources 1304A-1304M can originate from different lasers or can be obtained by splitting the output from a single laser. In some examples, the optical switch 1306M can have a total of N₁ outputs, the optical switch 1306B can have N₂ outputs, and the k-th switch can have Nₖ outputs. The array of TX antennas contains a total of N=N₁+N₂+ . . . +N_{M} antennas, where N₁ antennas are connected to the output ports of the optical switch 1306A, N₂ antennas are connected to the output ports of the optical switch 1306B, and so on. The PIC 1300 depicted in FIG. 13 may be packaged into a LiDAR system like that shown in FIG. 5/FIG. 10, which can include an external optical element (not shown) that steers and collimates/focuses the emitted/received light. When all optical sources 1304A-1304M are simultaneously operating, a total of M transmit antennas can simultaneously emit light, which can then be collimated and steered by the external optical element, resulting in a total of M distinct transmit beams being emitted at different angles by the system. Each of the M beams can scatter off targets located at the respective angles in the field of view. The scattered light arriving back at the LiDAR system can be focused by the external optical element into the antennas residing in the array of RX antennas 1310, where scattered light associated with a beam emitted by a TX antenna located at a given y-coordinate will be focused into the corresponding RX antenna located at the same y-coordinate. Since the external optical element can separate scattered light into different RX antennas depending on the angle at which the light is incident on the system, light that simultaneously arrives from different points in the field of view can be separated and routed into different IQ detectors connected to different amplifiers in the amplifier array. If the relevant amplifiers in the array are all operated simultaneously, all M points in the field of view can be imaged simultaneously. Operating the system using this type of parallelized architecture can enable the number of imaged points per second to be increased.

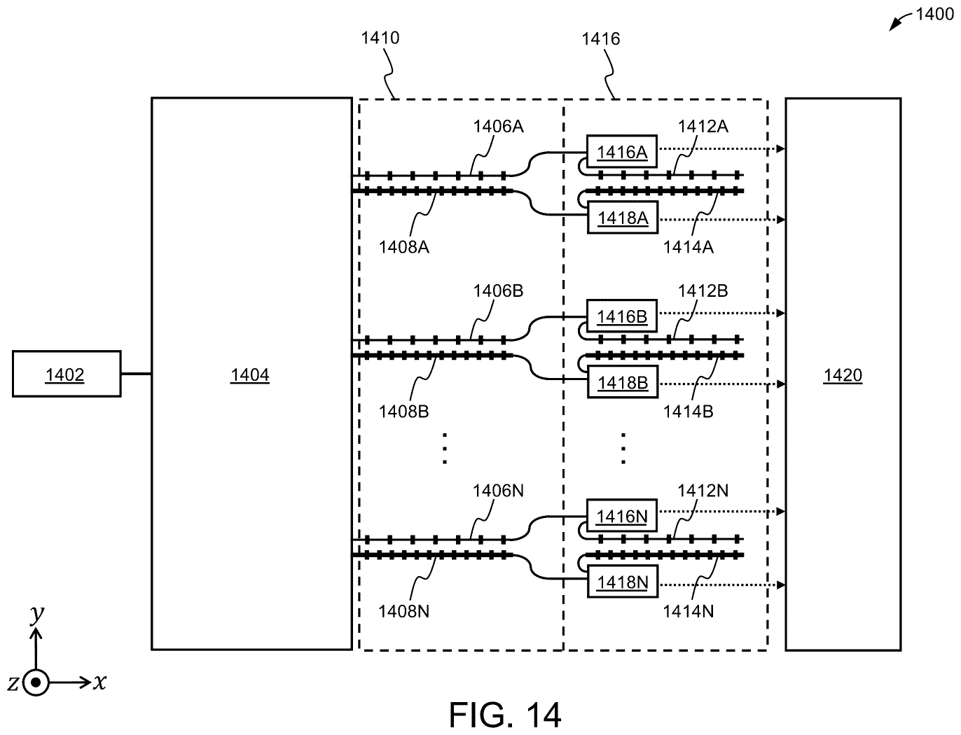

The architecture can also be modified to increase the steering range along the direction in which steering is achieved by varying the wavelength, which can be referred to as the wavelength axis. This modification is illustrated in FIG. 14, which depicts an example PIC 1400. The PIC 1400 comprises an optical source 1402 connected to an optical switch 1404. The optical switch is connected to a first plurality of TX antennas 1406A-1406N and a second plurality of TX antennas 1408A-1408N. The first plurality of TX antennas 1406A-1406N and a second plurality of TX antennas 1408A-1408N are each distributed along the y-axis and form an array of TX antennas 1410. Each TX antenna of the second plurality of TX antennas 1408A-1408N is positioned in proximity to a different respective TX antenna of the first plurality of TX antennas 1406A-1406N within a distance along the y-axis that is less than a minimum distance along the y-axis between any two different TX antennas of the first plurality of TX antennas 1406A-1406N. Each TX antenna of the first plurality of TX antennas 1406A-1406N are designed with a grating pitch that differs from the grating pitch of the TX antennas of the second plurality of TX antennas 1408A-1408N. In other words, the array of TX antennas 1410 is a set of four or more optical antenna elements comprising a first subset of two or more optical antenna elements having a first pitch of grating elements, i.e., the first plurality of TX antennas 1406A-1406N, and a second subset of two or more optical antenna elements having a second pitch of grating elements, i.e., the second plurality of TX antennas 1408A-1408N, where the first pitch is different from the second pitch.

Using this configuration, when the wavelength of the source light is swept over some specified bandwidth, the beam emitted from a TX antenna of the first plurality of TX antennas 1406A-1406N sweeps over a different range of angles along the x-axis compared to the beam emitted from a TX antenna of the second plurality of TX antennas 1408A-1408N. The angular range associated with the first plurality of TX antennas 1406A-1406N can partially, but not fully, overlap with the angular range associated with the second plurality of TX antennas 1408A-1408N. As a result, given a limited bandwidth over which the wavelength can be swept, the angular range along the x-axis that can be scanned by the combination of the first plurality of TX antennas 1406A-1406N and the second plurality of TX antennas 1408A-1408N is larger than the angular range that can be scanned by either one of the plurality of TX antennas alone. As shown in FIG. 14, the array of TX antennas 1410 is shown as consisting of pairs of the first plurality of TX antennas 1406A-1406N and the second plurality of TX antennas 1408A-1408N that are positioned close to each other along the y-direction. Because each TX antenna of the second plurality of TX antennas 1408A-1408N is displaced slightly along the y-direction compared to a respective TX antenna of the first plurality of TX antennas 1406A-1406N, the field of view can be slightly shifted from what it would be if the displacement were not present. Here, the field of view is along the direction in which steering is achieved by operating the switch to select the TX antenna from which light is emitted of the second plurality of TX antennas 1408A-1408N. However, because this displacement is less than the distance between a TX antenna of the first plurality of TX antennas 1406A-1406N and its nearest neighboring TX antenna of the first plurality of TX antennas 1406A-1406N, the shift of the field of view can also be small.

The PIC 1400 further comprises a first plurality of RX antennas 1412A-1412N and a second plurality of RX antennas 1414A-1414N forming an array of RX antennas 1416. Each TX antenna of the first plurality of TX antennas 1406A-1406N corresponds to a different respective RX antenna of the first plurality of RX antennas 1412A-1412N arranged at the same y coordinate and distributed along the x-axis. Likewise, each TX antenna of the second plurality of TX antennas 1408A-1408N corresponds to a different respective RX antenna of the second plurality of RX antennas 1414A-1414N arranged at the same y coordinate and distributed along the x-axis. Each RX antenna of the first plurality of RX antennas 1412A-1412N is designed to receive light from a target illuminated by a beam emitted by a corresponding TX antenna of the first plurality of TX antennas 1406A-1406N. Likewise, each RX antenna of the second plurality of RX antennas 1414A-1414N is designed to receive light from a target illuminated by a beam emitted by a respective TX antenna of the second plurality of TX antennas 1408A-1408N. In some implementations, the first plurality of TX antennas 1406A-1406N and the first plurality of RX antennas 1412A-1412N can each have the same grating pitch while the second plurality of TX antennas 1408A-1408N and the second plurality of RX antennas 1414A-1414N can each have the same grating pitch. Each RX antenna of the first plurality of RX antennas 1412A-1412N are connected to a different respective detector 1416A-1416N and each RX antenna of the second plurality of RX antennas 1414A-1414N is connected to a different respective detector 1418A-1418N. Each detector 1416A-1416N receives LO power from a respective TX antenna of the first plurality of TX antennas 1406A-1406N and each detector 1418A-1418N receives LO power from a respective TX antenna of the second plurality of TX antennas 1408A-1408N. Each detector 1416A-1416N, 1418A-1418N outputs a signal to an array of amplifiers 1420.

As shown in FIG. 14, light can be routed into any of the TX antennas in the array of TX antennas 1410 using the optical switch 1404. The optical switch comprises 2N output ports, where N is the number of TX antennas in the first plurality of TX antennas 1406A-1406N, which is equal to the number of TX antennas in the second plurality of TX antennas 1408A-1408N. switch. By sweeping over the full set of 2N optical switch configurations and sweeping the wavelength over the full bandwidth for each switch configuration, the emitted beam can be scanned over a two-axis field of view which is larger along the wavelength axis due to the use of both the first plurality of TX antennas 1406A-1406N and the second plurality of TX antennas 1408A-1408N.

While two types of TX antennas comprising different grating pitches are depicted in the PIC 1400 of FIG. 14, some configurations can use more than two types of TX antennas to increase the steering range of the LiDAR system.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus for managing optical waves transmitted to and received from a target region, comprising:
one or more photonic integrated circuits comprising:
an optical switching element configured to provide light from at least one optical source to a selected output port of two or more output ports of the optical switching element based on a selection signal,
a first set of two or more optical antenna elements optically coupled to respective output ports of the optical switching element and distributed along a first axis, and
a second set of two or more optical antenna elements arranged such that each optical antenna element in the second set is separated from a different respective optical antenna element in the first set along at least one of the first axis or a second axis perpendicular to the first axis, where each optical antenna element in the second set is positioned with respect to a different respective optical antenna element in the first set within a distance along the first axis that is less than a minimum distance along the first axis between any two different optical antenna elements in the first set; and
at least one optical element that has a first surface that:
is separated from the one or more photonic integrated circuits along a third axis perpendicular both the first axis and the second axis,
is positioned to relay optical waves from each of the optical antenna elements in the first set to the target region, and to relay optical waves from the target region to each of the optical antenna elements in the second set,
intersects a plane perpendicular to the second axis along a first curved line, and
intersects a plane perpendicular to the first axis along a first straight line that is substantially parallel to the second axis.

2. The apparatus of claim 1, wherein the first surface is configured to relay the optical waves from each of the optical antenna elements in the first set by reflection from an at least partially reflective portion of the first surface.

3. The apparatus of claim 2, wherein the at least partially reflective portion of the first surface has an optical reflectivity of at least 80% over a range of wavelengths that includes wavelengths of the relayed optical waves.

4. The apparatus of claim 2, wherein the at least partially reflective portion of the first surface is concave with respect to a side of the first surface upon which the relayed optical waves are incident when being reflected.

5. The apparatus of claim 1, wherein each optical antenna element in the second set is separated from a different respective optical antenna element in the first set along the second axis.

6. The apparatus of claim 5, wherein
each optical antenna element in the first set comprises a respective grating antenna that comprises: a respective optical waveguide having a propagation axis, and a plurality of grating elements distributed along the propagation axis of the respective optical waveguide; and
each optical antenna element in the second set comprises a respective grating antenna that comprises: a respective optical waveguide having a propagation axis, and a plurality of grating elements distributed along the propagation axis of the respective optical waveguide.

7. The apparatus of claim 6, wherein the second set of two or more optical antenna elements are arranged such that each optical antenna element in the second set is aligned with a different respective optical antenna element in the first set such that their respective propagation axes are substantially parallel to each other.

8. The apparatus of claim 7, further comprising a third set of two or more optical antenna elements arranged such that each optical antenna element in the third set is separated from a different respective optical antenna element in the second set along the second axis.

9. The apparatus of claim 8, wherein each optical antenna element in the third set comprises a grating antenna that comprises: a respective optical waveguide having a propagation axis, and a plurality of grating elements distributed along the propagation axis of the respective optical waveguide.

10. The apparatus of claim 9, wherein the third set of two or more optical antenna elements are arranged such that each optical antenna element in the third set is aligned with a different respective optical antenna element in the second set such that their respective propagation axes are substantially parallel to each other.

11. The apparatus of claim 9, wherein the respective waveguide of each optical antenna element in the first set has a length along its propagation axis no longer than L, and the respective waveguide of each optical antenna element in the second set and the third set has a length along its propagation axis no longer than 2L.

12. The apparatus of claim 6, further comprising the optical source configured to change a wavelength of the light provided to the optical switching element to steer an optical wave emitted from an optical antenna element in the first set incident on the first surface along a portion of the first straight line that is substantially parallel to the second axis.

13. The apparatus of claim 6, wherein the first set of two or more optical antenna elements comprises four or more optical antenna elements, including a first subset of two or more optical antenna elements, each optical antenna element of the first subset having a first pitch of grating elements distributed along the propagation axis of the optical waveguide, and a second subset of two or more optical antenna elements, each optical antenna element of the second subset having a second pitch of grating elements distributed along the propagation axis of the optical waveguide, where the second pitch is different from the first pitch.

14. The apparatus of claim 13, wherein each optical antenna element in the second subset is in proximity to a different respective optical antenna element in the first subset within a distance along the first axis that is less than a minimum distance along the first axis between any two different optical antenna elements in the first subset.

15. The apparatus of claim 1, wherein the optical switching element comprises:
an optical distribution network configured to distribute light from the optical source to a plurality of waveguides,
a plurality of phase shifters, each phase shifter configured to impose a respective phase shift on light propagating in a different respective waveguide of the plurality of waveguides, where at least some of the imposed phase shifts are dependent on the selection signal, and
a slab that is at least partially optically transmissive configured to propagate light that has been phase shifted by the plurality of phase shifters to constructively interfere at a selected output port of the two or more output ports of the optical switching element based on the dependence of the imposed phase shifts on the selection signal.

16. The apparatus of claim 1, wherein the at least one optical element comprises a first optical element and a second optical element, where the first surface is a first surface of the first optical element, and the second optical element has a second surface that:
is closer to the one or more photonic integrated circuits along the third axis than the first surface of the first optical element,
is positioned along with the first surface of the first optical element to relay optical waves from each of the optical antenna elements in the first set to the target region, and to relay optical waves from the target region to each of the optical antenna elements in the second set,
intersects the plane perpendicular to the second axis along a second curved line with different curvature than the first curved line, and
intersects the plane perpendicular to the first axis along a second straight line that is substantially parallel to the second axis.

17. The apparatus of claim 1, wherein each optical antenna element in the second set is optically coupled to a phase-sensitive detector that is optically coupled to a local oscillator optical wave for coherent detection of optical waves relayed from the target region.

18. The apparatus of claim 17, wherein the local oscillator optical wave optically coupled to each phase-sensitive detector is provided from an optical wave that propagates out of a portion of a different respective optical antenna element in the first set.

19. The apparatus of claim 17, further comprising electronic circuitry configured to perform light detection and ranging (LiDAR) to estimate a distance to a portion of the target region based at least in part on coherent detection of the optical waves relayed from the target region.

20. A method for fabricating a device for managing optical waves transmitted to and received from a target region, the method comprising:
forming one or more photonic integrated circuits comprising:
an optical switching element configured to provide light from at least one optical source to a selected output port of two or more output ports of the optical switching element based on a selection signal,
a first set of two or more optical antenna elements optically coupled to respective output ports of the optical switching element and distributed along a first axis, and
a second set of two or more optical antenna elements arranged such that each optical antenna element in the second set is separated from a different respective optical antenna element in the first set along at least one of the first axis or a second axis perpendicular to the first axis, where each optical antenna element in the second set is positioned with respect to a different respective optical antenna element in the first set within a distance along the first axis that is less than a minimum distance along the first axis between any two different optical antenna elements in the first set; and
forming at least one optical element that has a first surface that:
is separated from the one or more photonic integrated circuits along a third axis perpendicular both the first axis and the second axis,
is positioned to relay optical waves from each of the optical antenna elements in the first set to the target region, and to relay optical waves from the target region to each of the optical antenna elements in the second set,
intersects a plane perpendicular to the second axis along a first curved line, and
intersects a plane perpendicular to the first axis along a first straight line that is substantially parallel to the second axis.

21. A method for managing optical waves transmitted to and received from a target region, the method comprising:
from one or more photonic integrated circuits:
providing light using an optical switching element from at least one optical source to a selected output port of two or more output ports of the optical switching element based on a selection signal,
transmitting light from a first set of two or more optical antenna elements optically coupled to respective output ports of the optical switching element and distributed along a first axis, and
receiving light into a second set of two or more optical antenna elements arranged such that each optical antenna element in the second set is separated from a different respective optical antenna element in the first set along at least one of the first axis or a second axis perpendicular to the first axis, where each optical antenna element in the second set is positioned with respect to a different respective optical antenna element in the first set within a distance along the first axis that is less than a minimum distance along the first axis between any two different optical antenna elements in the first set; and
relaying light using at least one optical element that has a first surface that:
is separated from the one or more photonic integrated circuits along a third axis perpendicular both the first axis and the second axis,
is positioned to relay optical waves from each of the optical antenna elements in the first set to the target region, and to relay optical waves from the target region to each of the optical antenna elements in the second set,
intersects a plane perpendicular to the second axis along a first curved line, and
intersects a plane perpendicular to the first axis along a first straight line that is substantially parallel to the second axis.
